(19) United States
(12) Patent Application Publication
(10) Pub. No.: US 2022/0100134 A1
(43) Pub. Date: Mar. 31, 2022

(54) BELT UNIT AND FIXING DEVICE

(71) Applicant: CANON KABUSHIKI KAISHA, Tokyo (JP)

(72) Inventors: Akitomo Miyamoto, Ibaraki (JP); Kazuki Tada, Chiba (JP); Masayuki Tamaki, Chiba (JP)

(21) Appl. No.: 17/544,838

(22) Filed: Dec. 7, 2021

Related U.S. Application Data
(63) Continuation of application No. PCT/JP2020/025931, filed on Jun. 25, 2020.

(30) Foreign Application Priority Data
Jun. 28, 2019 (JP) 2019-121150
Jun. 28, 2019 (JP) 2019-121154

(51) Int. Cl. G03G 15/20

(52) U.S. Cl. CPC G03G 15/2053; G03G 2215/2025; G03G 15/2064

(57) ABSTRACT

A heater 600 includes a substrate 610 and a plurality of heat generating elements 623a to 623f which are provided on both surfaces of the substrate 610 and which generate heat, and heats a fixing belt in contact with an inner peripheral surface of the fixing belt. The plurality of heat generating elements 623a to 623f are different from each other in length with respect to a widthwise direction, and a plurality of the heat generating elements are provided on a front surface of the substrate 610 which is a side where the heater 600 contacts the inner peripheral surface of the fixing belt 600, and at least one of the heat generating elements is provided on a back surface. A length, with respect to the widthwise direction, of the heat generating element 623e which is provided on the back surface and which is longest in length with respect to the widthwise direction is shorter than a length, with respect to the widthwise direction, of the heat generating element 623c which is provided on the front surface and which is shortest in length with respect to the widthwise direction.

### TECHNICAL FIELD

The present invention relates to a belt unit for fixing a toner image on a recording material, and a fixing device including the belt unit.

### BACKGROUND ART

As the fixing device, a constitution in which a fixing belt for heating the recording material is heated by a heater has been conventionally known. Further, as the heater, a constitution in which heat generating elements different in length from each other are disposed on both surfaces of a substrate and in which heating in conformity to a size of the recording material is capable of being made has been proposed (Japanese Laid-Open Patent Application 2016-24321).

### Problem to be Solved by the Invention

In such a constitution in which the heat generating elements are provided on each of the both surfaces of the heaters when a constitution in which the heat generating elements different in length from each other are disposed on each of the respective surfaces is employed, it is desirable that a thermo-conductive property of the heat generating element long in length to the fixing belt is further enhanced.

### Effect of the Invention

According to the present invention, it is possible to provide a belt unit capable of further enhancing the thermo-conductive property of the heat generating element long in length to the belt.

### BRIEF DESCRIPTION OF THE DRAWINGS

FIG. 1 is a schematic structural sectional view of an image forming apparatus according to a first embodiment.

FIG. 2 is a schematic structural sectional view of a fixing device according to the first embodiment.

FIG. 3 is a structural view of a heater and a heater control circuit according to the embodiment 1.

In FIG. 4, part (a) is a schematic structural top (plan) view of the heater according to the first embodiment on a back surface side, part (b) is similarly a schematic structural top view of the heater on a front surface side, and part (c) is an A-A sectional view of part (a).

FIG. 5 is a graph showing a relationship between a position of a heat generating element at a fixing nip in a recording material feeding direction and an input electric power to the heat generating element in order to make a temperature of a fixing film a predetermined temperature.

In FIG. 6, part (a) is a schematic structural top view of a heater according to a second embodiment on a back surface, part (b) is similarly a schematic structural top view of the heater on a front surface side, and part (c) is a B-B sectional view of a part (a).

FIG. 7 includes views of a fixing device according to a third embodiment, in which part (a) is a schematic structural sectional view, and part (b) is an enlarged view of a portion of part (a).

In FIG. 8, part (a) is a schematic structural top view of a heater according to the third embodiment on a front surface side, and part (b) is similarly a schematic structural top view of the heater on a back surface side.

In FIG. 9, part (a) is an A-A sectional view of part (b) of FIG. 7, and part (b) is an enlarged view of a portion of part (a).

FIG. 10 is a view showing a periphery of an end portion of the heat generating element of the heater on the front surface side in an enlarged state.

FIG. 11 is a graph showing a relationship between a position of a heat generating element at a fixing nip in a recording material feeding direction and an input electric power to the heat generating element in order to make a temperature of a fixing film a predetermined temperature.

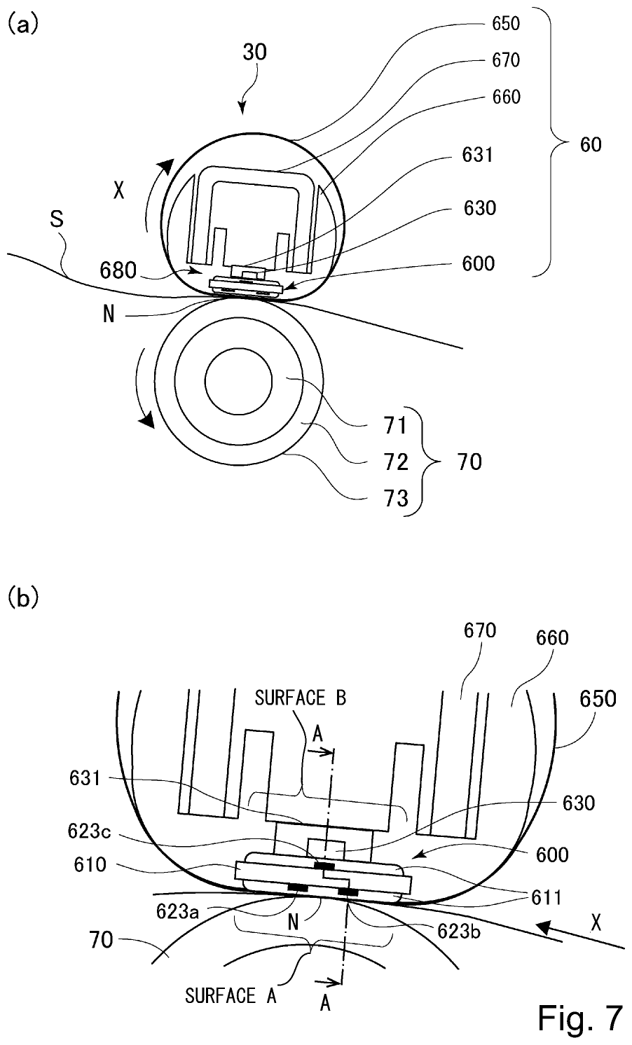

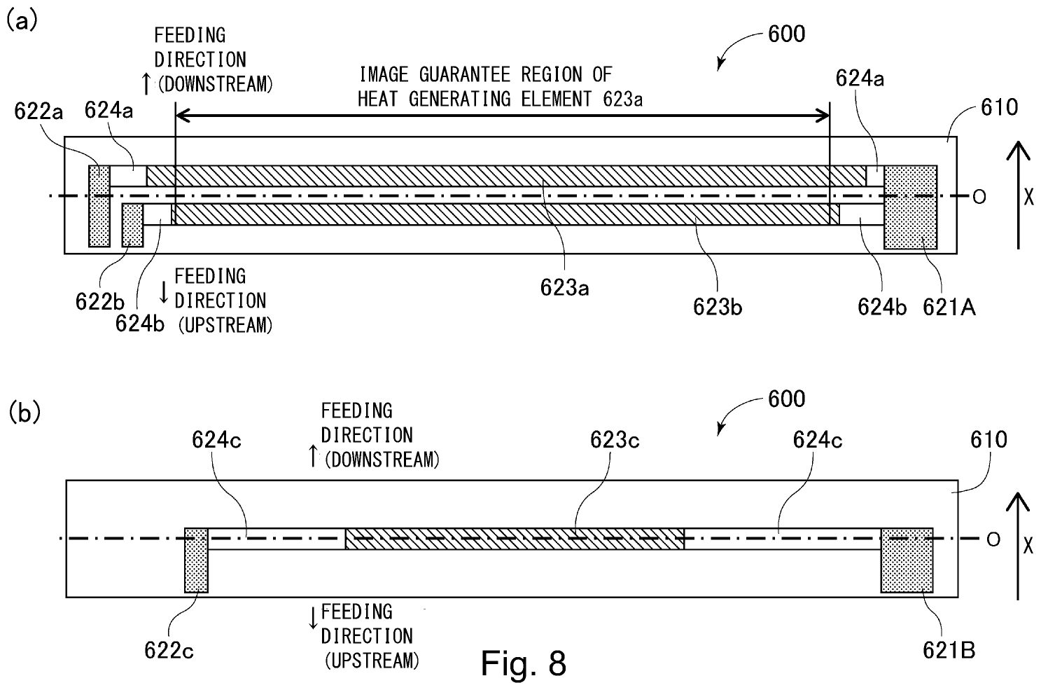

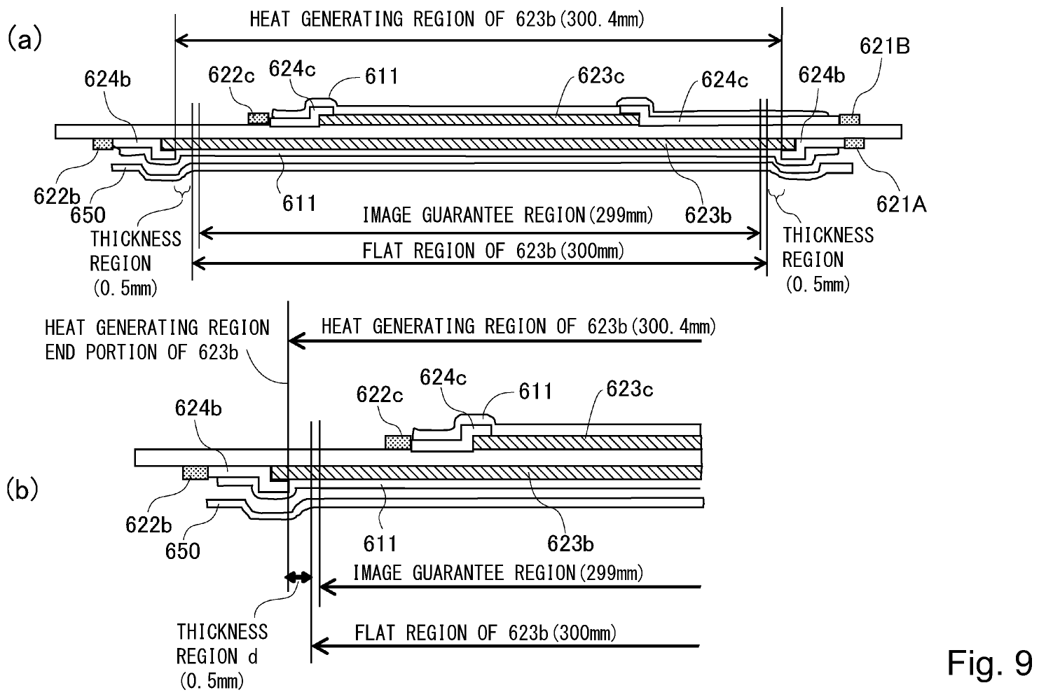

In FIG. 12, part (a) is a schematic structural top view of a heater according to a fourth embodiment on a front surface side, part (b) is similarly a schematic structural top view of the heater on a back surface side, and part (c) is a view similar to part (b) of FIG. 7.

In FIG. 13, part (a) is a schematic structural top view of a heater according to a fifth embodiment on a front surface side, and part (b) is similarly a schematic structural top view of the heater on a back surface side.

In FIG. 14, part (a) is a schematic structural top view of a heater according to a sixth embodiment on a front surface side, and part (b) is similarly a schematic structural top view of the heater on a back surface side.

### EMBODIMENTS FOR CARRYING OUT THE INVENTION

### First Embodiment

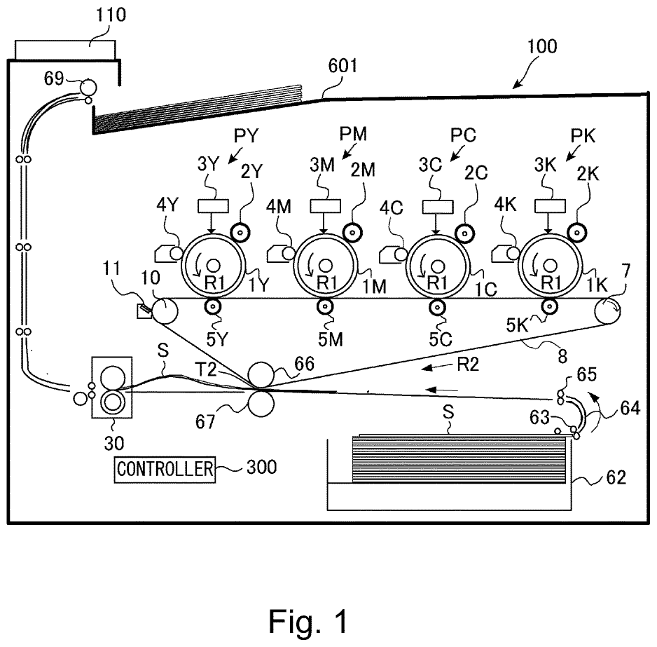

A first embodiment will be described using FIG. 1 to FIG. 5. First, a schematic structure of an image forming apparatus of this embodiment will be described using FIG. 1.

### [Image Forming Apparatus]

An image forming apparatus 100 shown in FIG. 1 is a full-color printer of an electrophotographic type including image forming portions PY, PM, PC and PK for four colors (yellow, magenta, cyan and black) in an apparatus main assembly. In this embodiment, an intermediary tandem type in which the image forming portions PY, PM, PC and PK are disposed along a rotational direction of an intermediary transfer belt described later. The image forming apparatus 100 forms a toner image (image) on a recording material S depending on an image signal from an original reading device (not shown) connected to the apparatus main assembly or from a host device such as a personal computer communicatably connected to the apparatus main assembly. As the recording material S, a sheet material, such as a sheet, a plastic film, or a cloth can be cited.

First, a recording material feeding process of the image forming apparatus 100 will be described. The recording materials S are accommodated in the form such that the recording materials S are stacked in a cassette 62, and are fed one by one to a feeding path 64 in synchronism with an image forming timing, by a feeding roller 63. Further, recording materials S stacked on an unshown manual feeding tray may also be fed one by one to the feeding path 64. When the recording material S is fed to a registration roller 65 disposed in an intermediary part of the feeding path 64, the recording material S is sent to a secondary portion T2 after being subjected to oblique movement correction and timing correction thereof by the registration roller 65. The secondary transfer portion T2 is, as described later, a transfer nip formed by a portion of the intermediary transfer belt 8, stretched by an inner secondary transfer roller 66, and by an outer secondary transfer roller 67. At the secondary transfer portion T2, a secondary transfer voltage is applied to the inner secondary transfer roller 66, so that the toner image is secondary transferred from the intermediary transfer belt 8 onto the recording material S.

Relative to the above-described feeding process of the recording material S to the secondary transfer portion T2, a forming process of the toner image sent to the secondary transfer portion T2 at a similar timing will be described. First, the image forming portions PY-PK will be described. However, the image forming portions PY-PK are constituted substantially identically except that colors of toners used in developing devices 4Y, 4M, 4C and 4K are different from each other. Therefore, in the following, as a representative, the image forming portion PY for yellow will be described as an example, and other image forming portions PM, PC and PK will be omitted from description.

The image forming portion PY is principally constituted by a photosensitive drum 1Y, a charging device 2Y, an exposure device 3Y, the developing device 4Y, and the like. A surface of the photosensitive drum (cylindrical photosensitive member) 1Y as an image bearing member rotationally driven is electrically charged uniformly in advance by the charging device 2Y, and thereafter, an electrostatic latent image is formed by the exposure device 3 driven on the basis of a signal of image information. Next, the electrostatic latent image formed on the photosensitive drum 1Y is developed with the toner by the developing device 4Y, and is visualized as the toner image. Thereafter, a predetermined pressure and a predetermined primary transfer bias are applied by a primary transfer roller 5Y disposed opposed to the photosensitive drum 1Y while sandwiching the intermediary transfer belt 8 therebetween, so that the toner image formed on the photosensitive drum 1Y is primary-transferred onto the intermediary transfer belt 8. Transfer residual toner slightly remaining on the photosensitive drum 1Y after the primary transfer is removed by an unshown cleaning blade or the like, and the photosensitive drum 1Y is prepared for a subsequent image forming process.

The intermediary transfer belt 8 as an intermediary transfer member is stretched by a tension roller 10, the inner secondary transfer roller 66, and a driving roller 7. Then, the intermediary transfer belt 8 is driven by the driving roller 7 so as to move toward an arrow R2 direction in the figure. The image forming portions for the respective colors processed by the above-described image forming portions PY-PK are carried out at timings when the toner image is sequentially superposed on the toner image primary-transferred on the intermediary transfer belt 8 and for an upstream color with respect to a movement direction. As a result, finally, a full-color toner image is formed on the intermediary transfer belt 8 and is fed to the secondary transfer portion T2. Incidentally, transfer residual toner after passing through the secondary transfer portion is removed from the intermediary transfer belt 8 by a transfer cleaner device 11.

By the feeding process and the image forming processes each described above, the toner image is secondary-transferred from the intermediary transfer belt 8 onto the recording material S. Thereafter, the recording material S is fed toward a fixing device 30 and is pressed and heated by the fixing device 30, whereby the toner image is melted and fixed on the recording material S. The recording material S on which the toner image is thus fixed is discharged onto a discharge tray 601 by a discharging roller 69. Incidentally, the image forming apparatus 100 includes a controller 300 for carrying out various pieces of control such as the above-described image forming operations and the like. Further, the above-described series of image forming operations are controlled by the controller 300 in accordance with respective input signal via an operating portion 110 on an upper surface of the apparatus main assembly or via a network.

### [Fixing Device]

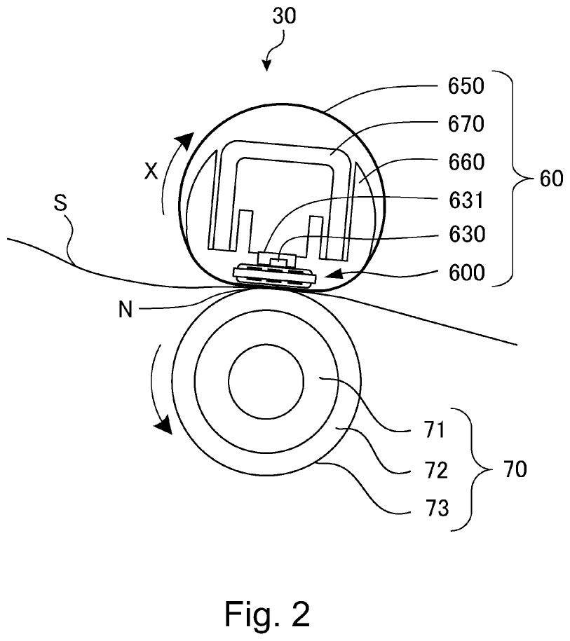

Next, the fixing device 30 of this embodiment will be described using FIG. 2. Here, the fixing device is required to meet shortening of a warm-up time by a quick temperature rise and recording materials of various sizes. In the case where thermal capacity of a heater of the fixing device is made small in order to shorten the warm-up time, a heater provided with only a heat generating element with a length in conformity to a width of a recording material with a maximum size would be considered. However, in this case, a temperature becomes excessively high in a non-passing region where the recording material does not pass through a fixing nip relative to a passing region where the recording material passes through the fixing nip. For this reason, conventionally, it has been requirement that a temperature rise in the non-passing region is suppressed. In this embodiment, by causing a heater 600 of the fixing device 30 to have a constitution including a plurality of heat generating elements corresponding to a plurality of sizes of the recording materials, the temperature rise in the non-passing region is suppressed.

As shown in FIG. 2, the fixing device 30 of this embodiment includes a fixing belt unit 60 and a pressing roller 70, and is provided so as to mountable in and dismountable from the apparatus main assembly of the image forming apparatus 100 (see FIG. 1). The fixing belt unit 60 includes a fixing belt 650 and a heater 600 and the fixing belt 650 is heated by the heater 600 although described later specifically.

The pressing roller 70 as a pressing member is rotatably supported by the apparatus main assembly. Further, the pressing roller 70 is disposed so that a longitudinal direction thereof is parallel to the fixing belt unit 60, and is provided so as to be pressed by the fixing belt unit 60 in contact with an outer peripheral surface of the fixing belt 650. The pressing roller 70 includes, for example, an about 3 μm-thick elastic layer 72 of a silicone rubber or the like on an outer periphery of a core metal 71 made of metal (for example, stainless steel) and an about 40 μm-thick parting-layer 73 comprising fluorine-containing resin such as PTFE, PFA, or FEP on an outer periphery of the elastic layer 72. The pressing roller 70 is rotatably supported by a device frame by being shaft-supported and held at both end portions of the core metal 71 rotatably between side plates of an unshown device frame.

Between the fixing belt 650 and the pressing roller 70, a fixing nip N is formed as described later. Therefore, when the pressing roller 70 is rotated by an unshown motor, by a frictional force generated in this fixing nip N, a rotational force of the pressing roller 70 is transmitted to the fixing belt 650. Thus, the fixing belt 650 is rotationally driven by the pressing roller 70 (so-called, a pressing roller driving type). The recording material S is nipped and fed in the fixing nip N formed by these rotating pressing roller 70 and fixing belt 650.

In the fixing device 30, energization to the heater 600 is carried out when the pressing roller 70 is rotationally driven and the cylindrical fixing belt 650 is in a follower rotation state therewith. Then, when a temperature of the heater 600 is in a state in which the temperature is rising temperature-controlled to a target temperature, the recording material S carrying thereon the unfixed toner image is guided and introduced along an unshown inlet guide into the fixing nip N.

In the fixing nip N, a toner image carrying surface side of the recording material S hermetically contacts an outer surface of the fixing belt 650, so that the recording material S moves together with the fixing belt 650. In a nip-feeding process of the recording material S in the fixing nip N, heat from the heater 600 is imparted to the recording material S via the fixing belt 650, so that the unfixed toner image is melted and fixed on the recording material S. The recording material S passed through the fixing nip N is separated and discharged from the fixing belt 650.

### [Fixing Belt Unit]

Next a constitution of the fixing belt unit 60 will be specifically described. The fixing belt unit 60 is provided in the apparatus main assembly so as to be movable toward the pressing roller 70 side. The fixing belt unit 60 includes the fixing belt 650, a heater holder 660, a stay 670, and the heater 600 which are non-rotationally disposed inside the fixing belt 650.

### [Fixing Belt]

The fixing belt (fixing film) 650 is formed in an endless shape (cylindrical shape) and has flexibility, and in the case of this embodiment, is a thin film-like belt. Such a fixing belt is one in which an elastic layer is formed on a base material, and further, an outermost surface layer is formed on the elastic layer. The base material is one prepared by forming, for example, stainless steel in a cylindrical shape in a thickness of 30 μm. The elastic layer is, for example, an about 300 μm-thickness silicone rubber layer (elastic layer), and is formed on the base material by an appropriate method such as a ring coating method. The outermost surface layer is, for example, a 20 μm-thick PFA resin tube on which the elastic layer is coated. Further, onto an inner peripheral surface of the fixing belt 650, grease as a lubricant is applied. This is because a sliding property between the inner peripheral surface of the fixing belt 650 and the heater holder is improved. Incidentally, as the base material of the fixing belt 650, other than the stainless steel, a nickel-based metal material, a heat-resistant resin such as polyimide, and the like may also be used.

The fixing belt 650 is capable of being mounted in and dismounted from the heater holder 660 described later, and is supported so as to be rotatable and be restricted in movement of a widthwise direction by unshown flange portion disposed at both end portions with respect to the widthwise direction (longitudinal direction) crossing the rotational direction of the fixing belt 650. That is, the flange portions include cylindrical portions which are fitted into end portions of the fixing belt 650 with respect to the widthwise direction and which rotatably supports the end portions of the fixing belt 650 with respect to the widthwise direction, and include contact portions contactable to end edges of the fixing belt 650 with respect to the widthwise direction. The cylindrical portions guide rotation of the fixing belt 650 while holding the end portions of the fixing belt 650 with respect to the widthwise direction in a cylindrical state from the inside of the fixing belt 650.

Here, the pressing roller 70 and the fixing belt 650 are disposed in a state in which these roller and belt are slightly deviated from a parallel state due to a mounting error of the pressing roller 70 and the fixing belt unit 60, or the like in some cases. In that case, the fixing belt 650 is capable of shifting and moving in the widthwise direction while rotating in an arrow X direction in the figure by the rotating pressing roller 70. For this reason, when the fixing belt 650 shifts and moves in the widthwise direction, the contact portion of the flange portion receives the end portion of the fixing belt 650 with respect to the widthwise direction and restricts movement of the fixing belt 650 in the widthwise direction. Incidentally, the heater holder 660 and the stay 670 are mounted to the flanges, and are non-rotationally disposed inside the fixing belt 650. The flange portions are held by unshown side plates or the like of the fixing belt unit 60.

### [Stay]

The stay 670 is a rigid member (metal plate) which extends along the fixing belt 650 in the widthwise direction and which is made of, for example, metal, and herein, is formed in a substantially U-character shape in cross-sectional surface so as to be provided with an opening on the heater holder 660 side. This stay 670 reinforces the heater holder 660 so as not to be deformed, by a pressing force acting between the fixing belt unit 60 and the pressing roller 70. To the stay 670, the above-described flange portions are fixed at both end portions of the stay 670 with respect to the widthwise direction. The flange portions at the both end portions are pressed toward the pressing roller 70 at a predetermined pressing force (for example, 90-320 N) by an unshown pressing mechanism. By this, the pressing force acts on the fixing belt 650 from the flange portions via the stay 670 and the heater holder 660, so that the fixing belt 650 and the pressing roller 70 are press-contacted by a desired press-contact force. By press-contacting the fixing belt 650 and the pressing roller 70 to each other, between the fixing belt 650 and the pressing roller 70, the fixing nip N having a predetermined width with respect to the feeding direction of the recording material S is formed. The recording material S on which the toner image is formed is pressed and fed at the fixing nip N. Incidentally, the stay 670 may also be formed in a shape such that the stay 670 slides on the inner peripheral surface of the fixing belt 650.

### [Heater Holder]

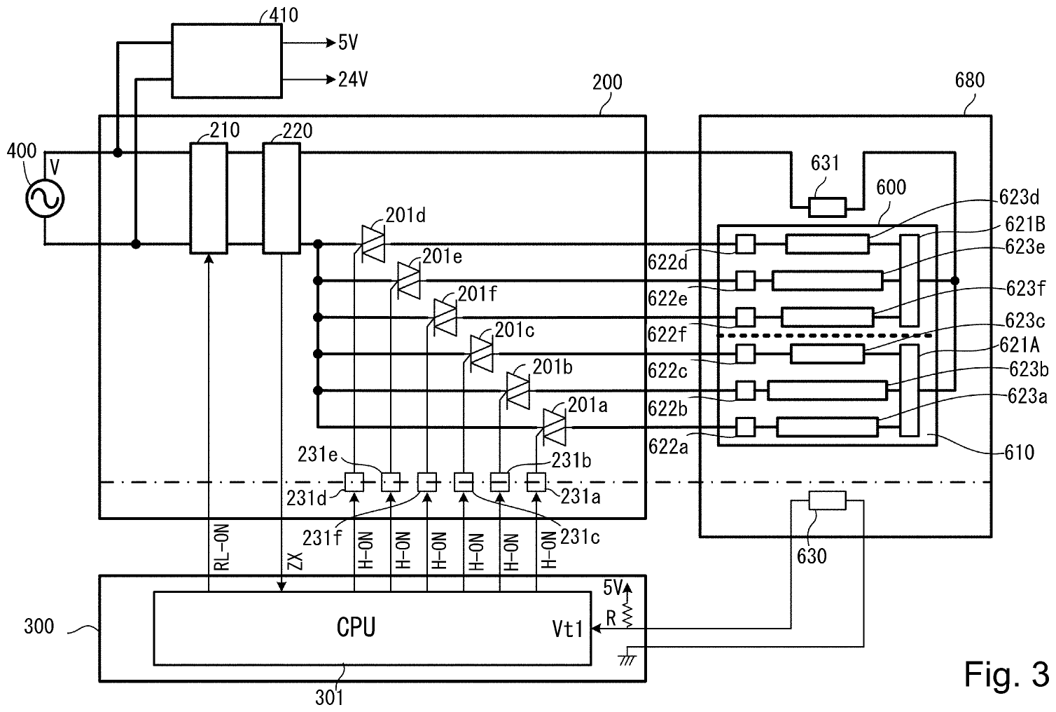

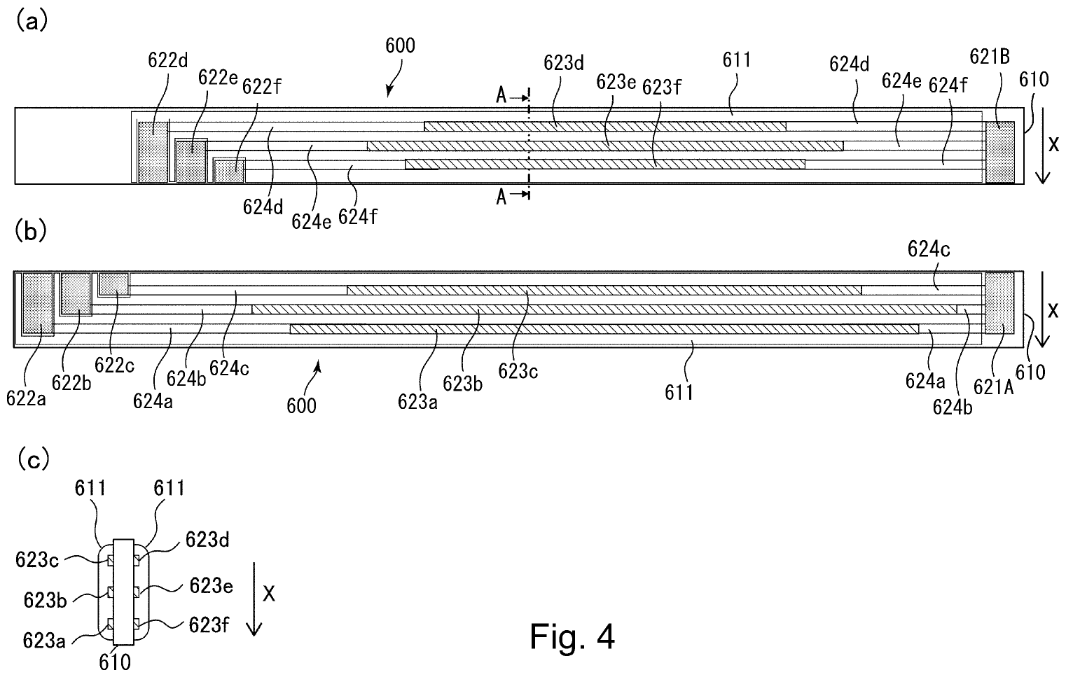

The heater holder 660 is, for example, formed by a member made of a resin, high in heat-resistant property and high in heat-insulating property, such as a liquid crystal polymer resin, and performs a function of not only holding the heater 600 but also guiding the fixing belt 650. On the heater holder 660, an engaging groove capable of engaging and holding the heater 600 is formed in a shape extending along the widthwise direction, at a surface on an opposite side (fixing nip N side) to a surface on the stay 670 side. The heater 600 held by the heater holder 660 is capable of heating the rotating fixing belt 650 of which surface is contacted to the inner peripheral surface of the fixing belt 650. By this, when the recording material S is nipped and fed by the fixing nip N, heat generated by the heater 600 is conducted to the recording material S, so that the unfixed toner image is heated and melted, and is fixed on the recording material S. The heater 600 is controlled by a heater control circuit 200 described later. These heater 600 and heater control circuit 200 will be specifically described later (see FIG. 3 described later).

### [Heater]

The heater 600 as a heating member includes a substrate 610, a plurality of heat generating elements 623a-623f, and a protective glass 611, which have an insulating property, a heat-resistant property, and a low thermal capacity with respect to the widthwise direction (which is also a direction perpendicular to a direction in which the recording material is fed in the fixing nip N9 as a longitudinal direction (parts (a) to (c) of FIG. 4). The heat generating elements 623a-623f are provided by a plurality (by three pieces in this embodiment) on each of a front surface (side) and a back surface (side). The protective glass 611 is provided on the front surface and the back surface of the substrate 610 in order to ensure the insulating property. Further, as described above, the heater 600 is fixedly supported by the heater holder 660. Such a heater 600 is a low thermal capacitance ceramic heater capable of rising in temperature with an abrupt rising characteristic by electric power supply to either one of the heat generating elements 623a-623f.

On the front surface side of the heater 600 contacting the inner peripheral surface of the fixing belt 650, as a sliding (friction) layer, for example, a polyimide layer of about 10 μm in thickness is formed. By forming the polyimide layer on the heater 600, a sliding (frictional) resistance between the fixing belt 650 and the heater 600 can be reduced, and thus it is possible to realize a reduction of a driving torque for rotating the fixing belt 650 and a reduction of abrasion by sliding of the fixing belt 650. Incidentally, in the case where as a base material of the fixing belt 650, a heat-resistant resin such as polyimide is used, the polyimide layer as a sliding layer of the heater 600 may also be omitted. A specific constitution of the heater 600 will be described later.

### [Temperature Sensor]

In order to control the temperature of the fixing belt 650 in this embodiment, a temperature sensor 630 for detecting a temperature of the heater 600 is provided. In this embodiment, for example, a contact-type temperature sensor 630 such as a thermistor sensor is employed. However, the temperature sensor 630 may also be of a non-contact type. The temperature sensor 630 is disposed inside the heater holder 660 so that a detecting portion contacts the back surface of the heater 600 on a side opposite from the fixing belt 650. Further, the temperature sensor is disposed singly at a central portion of the heater 600 with respect to the widthwise direction and the longitudinal direction, and detects the temperature of the heater 600 in the neighborhood of a center. Further, control for adjusting the temperature of the plurality of heat generating elements provided on the heater 600 is carried out by a common temperature sensor 630. Incidentally, the number of the temperature sensor 630 is not limited to one, but a plurality of temperature sensors 630 may also be disposed over the widthwise direction of the fixing belt 650. Further, in the case where the plurality of temperature sensors 630 exist, the temperature sensors 630 may also be shifted and disposed in the rotational direction of the fixing belt 650.

### [Thermostat]

Further, in this embodiment, a thermostat 631 is provided so as to cut off the electric power supply to the heater 600 when the temperature of the heater 600 exceeds a predetermined temperature. The thermostat 631 is a switch such that the electric power supply is cut off by opening a contact through a reversal of bimetal when, for example, the temperature becomes a predetermined temperature or more and that the electric power supply is started by closing the contact through returning of the bimetal to a state before the reversal when the temperature becomes lower than the predetermined temperature.

### [Heater Control]

Next, control of the heater 600 will be described using FIG. 3. In this embodiment, a heater unit 680 is constituted by the heater 600, the temperature sensor 630, and the thermostat 631. The heater unit 680 is controlled by the heater control circuit 200. The heater control circuit (driver circuit) 200 is one for adjusting a heat generating state including ON/OFF of energization to the heater 600 under control of the controller 300. The heater 600 is provided so as to be connectable to the heater control circuit 200.

The controller 300 carries out control of entirety of the image forming apparatus 100 in addition to the control of the heater 600. Such a controller 300 includes a CPU (Central Processing Unit) 301, a ROM (Read Only Memory), a RAM (Random Access Memory), and the like. The CPU 301 carries out control of respective portions while reading a program corresponding to a control procedure stored in the ROM. Further, in the RAM, data for an operation and input data are stored, and the CPU 301 carries out the control by making reference to the data stored in the RAM on the basis of the above-described program or the like. Incidentally, the controller 300 may also be one such as a micon prepared exclusively for control of the heater 600. In this case, the controller 300 may also be provided in the fixing device 30.

In the case of this embodiment, the controller 300 acquires a detection result of the temperature sensor 630, and is capable of controlling the heater control circuit 200 on the basis of the acquired detection result so that the temperature of the heater 600 is maintained at a target temperature (for example, about 200° C.). A heat generating state of the heater 600 is changed depending on control of the electric power supply to the heater 600 by the heater control circuit 200.

As regards electric power for generating the heater 600, electric power generated by a commercial power (voltage) source 400 is supplied via the heater control circuit 200. A DC voltage source 410 is a switching voltage source (ACDC voltage source) for supplying the electric power to each of loads on a secondary side in the image forming apparatus. The DC voltage source 410 generates DC voltages “5V” and “24V” on the secondary side from an AC voltage “100V” outputted by the commercial voltage source 410. The DC voltage “5V” generated by the DC voltage source 410 is used for driving the controller 300 and the like, the DC voltage “24V” is used for driving triac driving circuits 321a-231f and the like. Incidentally, the temperature sensor 630 has a property such that a resistance value of the temperature sensor 630 lowers as the temperature becomes higher, so that the temperature sensor 630 is capable of detecting the temperature at a component voltage “Vt1” for a resistance R with respect to a reference voltage “5V” of the controller 300.

The thermostat 631 is disposed in the neighborhood of a center of the heater 600, and is maintained in an open state through separation of an inside contact when the temperature reaches a predetermined temperature. Further, the thermostat 631 is connected between the heater control circuit 200 and the heater 600.

The heater control circuit 200 is a circuit which is connected to the commercial voltage source 400 and which supplies electric power to the DC voltage source 410 and the heater 600 in the fixing device 30, and an amount of electric power supply to the heater 600 is adjusted by a conduction ratio of the triacs 201a-201f Such a heater control circuit 200 includes a relay circuit 210, a zero-cross detecting circuit 220, a plurality (6 pieces in this embodiment) of triac driving circuits 231a-231f.

The relay circuit 210 is a circuit for cutting off the electric power supply to the fixing provided 30 in the case where the voltage outputted from the commercial power source 400 is an abnormal value, and is connected to the commercial voltage source 400. The relay circuit 210 is turned on and turned off in accordance with a relay ON signal (RL-ON) sent from the CPU 301 of the controller 300.

The zero-cross detecting circuit 220 is a circuit which detects a zero-cross timing of the AC voltage outputted from the commercial power source 400 and which outputs a zero-cross signal ZX. The outputted zero-cross signal EX is inputted to the controller 300 and is used for changing a conduction ratio of the triacs 201a-201f described later.

In order to carry out adjusting control of ON/OFF control of the electric power supply to the heater 600 and of the electric power supply amount, in this embodiment, the plurality of triacs 201a-201f are used. On the heater 600, three heat generating elements 623a-623c and three heat generating elements 623d-623f are provided on a front surface (first surface) of the substrate 610 on a side where the heater 600 contacts the inner peripheral surface of the fixing belt 650 and on a back surface (second surface) of the substrate 610 on a side opposite from the front surface, respectively. In FIG. 3, the heat generating elements 623a-623c on the front surface (a lower side of a broken line in the figure) and the heat generating elements 623d-623f on the back surface (an upper side of the broken line in the figure) are schematically shown by being vertically arranged. Details of the heater 600 will be described later.

In this embodiment, in order to independently operate these six heat generating elements 623a-623f, six triacs 201a-201f are provided. First, as regards the heat generating elements 623a-623c provided on the front surface of the substrate 610, the triac 201a is connected to the heat generating element 623a, the triac 201b is connected to the heat generating element 623b, and the triac 201c is connected to the heat generating element 623c, respectively. Further, as regards the heat generating elements 623d-623f, the triac 201d is connected to the heat generating element 623d, the triac 201e is connected to the heat generating element 623e, and the triac 201f is connected to the heat generating element 623f, respectively. These triacs 201a-201f are connected to the heat generating elements 623a-623f on one end side and are connected to the commercial power source 400 via the zero-cross detecting circuit 220 and the relay circuit 210 on the other side opposite from the one side with respect to the widthwise direction.

These triacs 201a-201f are connected to the triac driving circuits 231a-231f The triac driving circuits 231a-231f are capable of independently turning on and turning off the triacs 201a-201f in accordance with a heater ON signal (H-ON) appropriately sent from the CPU 301 of the controller 300. When the triacs 201a-201f are turned on, electric power supply to the heat generating elements 623a-623f connected to the triacs 201a-201f which are turned on, so that the heat generating elements 623a-623f generate heat.

The triac driving circuits 231a-231f are capable of changing the conduction ratio of the triacs 201a-201f in accordance with a timing change of the heater ON signal (H-ON) sent from the CPU 301 of the controller 300. By changing the conduction ratio of the triacs 201a-201f, the electric power supply amount to the heat generating elements 623a-623f is changed. For example, when the conduction ratio of the triacs 201a-201f is made high, the electric power supply amount to the heat generating elements 623a-623f becomes large, so that a heat generation temperature of the heat generating elements 623a-623f is capable of being made high. On the other hand, when the conduction ratio of the triac 201a-201f is made low, the electric power supply amount to the heat generating elements 623d-623f becomes small, so that the heat generation temperature of the heat generating elements 623d-623f is capable of being made low.

The CPU 301 controls the conduction ratio of the triacs 201a-201f so that a center temperature of the heater 600 becomes a target temperature (about +200° C.) by being monitored at the above-described voltage Vt1. Specifically, the CPU 301 changes a timing of the heater ON signal H-ON to the triac driving circuits 231a-231f.

In a control constitution of FIG. 3, the heat generating element to which electric power is supplied depending on a size of a selected recording material. For example, in the case where an A4-size sheet is selected as the recording material, the CPU 301 adjusts the amount of the electric power supply to the heat generating element 623b by changing the conduction ratio of the triac 201b with the H-ON signal, and thus controls the temperature at the target temperature.

Further, in the case where A5 lateral feeding (A5R) is selected, the CPU 301 adjusts the amount of the electric power supply to the heat generating element 623c by changing the conduction ratio of the triac 201b with the H-ON signal, and thus controls the temperature at the target temperature. Also, as regards another sheet size, a heat generating element corresponding to the sheet size is selected similarly, and temperature control is carried out by controlling the amount of the electric power supply to the heat generating element. Thus, in this embodiment, the heat generating element corresponding to a length (length with respect to a direction perpendicular to a sheet feeding direction), with respect to the widthwise direction, of a size of the sheet to be outputted, and control of energization to the selected heat generating element is carried out. For that reason, a constitution in which energization to the heat generating element which is not selected is not carried out is employed.

Further, when a center temperature of the heater 600 becomes high so as to be a predetermined value or more, the CPU 301 cuts off the electric power supply to the heater 600 by turning off the relay ON signal RL-ON and respective triac ON signals H-ON.

### [Details of Heater]

Next, details of the heater 600 of this embodiment will be described using part (a) of FIG. 4 to part (c) of FIG. 4 while making reference to FIG. 3. Part (a) of FIG. 4 shows a back surface side of the heater 600, part (b) of FIG. 4 shows a front surface (front face) side of the heater 600, and part (c) of FIG. 4 shows an A-A cross-sectional view of the heater 600. Incidentally, in part (a) of FIG. 4 to part (c) of FIG. 4, arrows X in the figures indicate a rotational direction of the fixing belt 650 in the fixing nip N, i.e., a recording material feeding direction (see FIG. 2).

The heater 600 as a heating member includes the substrate 610 and the plurality of heat generating elements 623a-623f which are provided on both surfaces of the substrate 610 and which generate heat by energization, and heats the fixing belt 650 by being contacted to the inner peripheral surface of the fixing belt 650. The substrate 610 has an insulating property and a heat-resistant property, and is formed by using a material with a further high thermo-conductive property, for example, ceramic such as alumina or aluminum nitride.

The plurality of heat generating elements 623a-623f are different from each other in length with respect to the widthwise direction crossing the rotational direction of the fixing belt 650 in other to meet recording materials of the plurality of sizes. These respective heat generating elements 623a-623f are provided substantially parallel to the widthwise direction, respectively. Further, the heat generating elements 623a-623f are disposed with intervals with each other with respect to the recording material feeding direction on the respective surfaces thereof. Further, on the front surface (first surface) of the substrate 610 which is a side where the heater 600 contacts the inner peripheral surface of the fixing belt 650, a plurality (for example, at least three pieces) of heat generating elements are provided. In this embodiment, three heat generating elements 623a-623c are provided on the front surface of the substrate 610. On the other hand, on the back surface (second surface) of the substrate 610 which is a side opposite from the front surface of the substrate 610, at least one heat generating element is provided. In this embodiment, three heat generating elements 623d-623f which are the same in number as those on the front surface are provided on the back surface of the substrate 610.

As shown in part (a) of FIG. 4, on the back surface of the substrate 610, the three heat generating elements 623d-623f different from each other in length with respect to the widthwise direction are printed and baked by using silver/palladium (Ag/Pd). Further, these heat generating elements 623d-623f are connected to three independent electrodes 622d-622f, respectively, on one end side with respect to the widthwise direction by electroconductive member patterns 624d-624f formed of silver (Ag) or the like, and are connected to a single common electrode 621B on the other end side by the electroconductive member patterns 624d-624f The three independent electrodes 622d-622f are connected to the above-described triacs 201d-201f, respectively (see FIG. 3). On the other hand, the common electrode 621B is connected to the commercial power source 400 via the above-described thermostat 631, and the zero-cross detecting circuit 220 and the relay circuit 210 of the heater control circuit 200 (see FIG. 3). Incidentally, these heat generating elements 623d-623f and electroconductive member patterns 624d-624f are, as shown in part (c) of FIG. 4, covered with the protective glass 611 of, for example, 60-90 μm in thickness.

As shown in part (b) of FIG. 4, also on the front surface of the substrate 610, similarly as the back surface, the three heat generating elements 623a-623c different from each other in length with respect to the widthwise direction are printed and baked by using silver/palladium (Ag/Pd). Further, these heat generating elements 623a-623c are connected to three independent electrodes 622a-622c, respectively, on one end side with respect to the widthwise direction by electroconductive member patterns 624a-624c formed of silver (Ag) or the like, and are connected to a single common electrode 621A on the other end side by the electroconductive member patterns 624a-624c. The three independent electrodes 622a-622c are connected to the above-described triacs 201a-201c, respectively (see FIG. 3). On the other hand, the common electrode 621A is connected to the commercial power source 400 via the above-described thermostat 631, and the zero-cross detecting circuit 220 and the relay circuit 210 of the heater control circuit 200 (see FIG. 3). Incidentally, these heat generating elements 623a-623c and electroconductive member patterns 624a-624c on the front surface are, similarly as the back surface, as shown in part (c) of FIG. 4, covered with the protective glass 611 of, for example, 60-90 μm in thickness.

Incidentally, in the case of this embodiment, the common electrodes 621A and 621B are formed at the substantially same position with respect to the widthwise direction on both surfaces of the substrate 610. On the other hand, the independent electrodes 622a-622c and the independent electrodes 622d-622f are formed at different positions with respect to the widthwise direction on both surfaces of the substrate 610. However, a positional relationship between the common electrodes 621A and 621B and a positional relationship between the independent electrodes 622a-622c and the independent electrodes 622d-622d are not limited to these.

### [Arrangement of Respective Heat Generating Elements]

Next, an arrangement of the plurality of heat generating elements 623a-623f will be described using part (a) of FIG. 4 to part (c) of FIG. 4 will be described. As regards the heater 600 of this embodiment, of the plurality of heat generating elements 623a-623f, the heat generating element 623b longest in length with respect to the widthwise direction is provided on a surface (surface on the fixing belt 650 side) on a side where the substrate 610 contacts the fixing belt 650. Further, the three heat generating elements 623a-623c provided on the front surface are the heat generating element 623b (first heat generating element), the heat generating element 623a (second heat generating element), and the heat generating element 623c (third heat generating element) in the order from the heat generating element with a longer length with respect to the widthwise direction. That is, among the heat generating elements provided on the front surface and the heat generating elements provided on the back surface (opposite surface from the first surface), the three heat generating elements longer in length are provided on the first surface. In this case, with respect to the rotational direction of the fixing belt 650, the longest heat generating element 623b with respect to the widthwise direction is disposed between the heat generating element 623a and the heat generating element 623c. Further, the heat generating elements 623a-623c are disposed in the order of the heat generating element 623c, the heat generating element 623b, and the heat generating element 623a from an upstream side to a downstream side with respect to the rotational direction of the fixing belt (from an upstream side to a downstream side with respect to a direction in which the recording material is fed in the fixing nip N, with respect to the arrow X direction).

On the other hand, on the back surface of the substrate 610, the three heat generating elements 623d-623f are provided. In this embodiment, also on the back surface, the three heat generating elements are provided. That is, the number of the heat generating elements provided on the first surface is the same as the number of the heat generating elements provided on the back surface. Further, the three heat generating elements 623d-623f provided on the back surface are the heat generating element 623e (fourth heat generating element), the heat generating element 623f (fifth heat generating element), and the heat generating element 623d (sixth heat generating element) in the order from the heat generating element with a longer length with respect to the widthwise direction. In this case, with respect to the rotational direction of the fixing belt 650, the longest heat generating element 623e with respect to the widthwise direction is disposed between the heat generating element 623f and the heat generating element 623d. Further, the heat generating elements 623d-623f are disposed in the order of the heat generating element 623d, the heat generating element 623e, and the heat generating element 623f from an upstream side to a downstream side with respect to the rotational direction of the fixing belt (from an upstream side to a downstream side with respect to a direction in which the recording material is fed in the fixing nip N, with respect to the arrow X direction).

That is, in this embodiment, not only on the front surface but also on the back surface, the longest heat generating element with respect to the widthwise direction is positioned at a central portion on each of the surfaces, and in the case where the heat generating elements on sides upstream of and downstream of this heat generating element are compared with each other, the heat generating element on the downstream side is longer in length with respect to the widthwise direction than the heat generating element on the upstream side. Incidentally, lengths of the heat generating elements on each of the surfaces are the same with respect to the rotational direction of the fixing belt 650. In this embodiment, the lengths of all the heat generating elements 623a-623f with respect to the rotational direction of the fixing belt 650 are the same.

Particularly, in the case of this embodiment, the length of the longest heat generating element 623e with respect to the widthwise direction provided on the back surface is shorter than the length of the shortest heat generating element 623c with respect to the widthwise direction provided on the front surface. That is, the lengths of all the heat generating elements with respect to the widthwise direction provided on the back surface is made shorter than the shortest heat generating element of the heat generating elements provided on the front surface. In other words, the heat generating elements are disposed on the front surface in the order from the longest heat generating element with respect to the widthwise direction. Specifically, the heat generating elements 623b, 623a and 623c which are long in the first, second and third are disposed on the front surface, and the heat generating elements 623e, 623f and 623d which are long in the fourth, fifth and sixth are disposed on the back surface.

Next, specific examples of the respective heat generating elements 623a-623f will be described. The six heat generating elements 623a-623f disposed on the both surfaces of the substrate 610 are different from each other in length, resistance value, and electric power in conformity with lengths of a plurality of sheets with respect to the widthwise direction. In a table 1, examples of the heat generating elements 623a-623f are shown. Incidentally, a “heat generating element length” in the table 1 is a length of the heat generating element with respect to the widthwise direction.

TABLE 1

| Surface | HGE*¹ | CSS*² | SW*³[mm] | HGEL*⁴[mm] |
|---|---|---|---|---|
| Front | 623b | A3/A4 | 297 | 318 |
| | 623a | LTR | 279.4 | 300.4 |
| | 623c | B4/B5 | 257 | 278 |
| Back | 623e | A4R/A5 | 210 | 231 |
| | 623f | B5R | 182 | 203 |
| | 623d | A5R | 148 | 169 |

*¹“HGE” is the heat generating element.
*²“CSS” is a corresponding sheet size.
*³“SW” is a sheet width.
*⁴“HGEL” is a heat generating element length.

Here, in the heater 600, heat generated by the heat generating elements on the back surface side of the substrate 610 is conducted to the fixing belt 650 via the substrate 610. For that reason, compared with the heat generating elements disposed on the front surface, the heat generating elements disposed on the back surface side are lowered in heat (thermal) conduction efficiency toward the fixing belt 650. In order to suppress a lowering in heat conduction efficiency toward the fixing belt 650, it is desirable that the heat generating elements are disposed on the front surface of the substrate 610. However, in a constitution including the plurality of heat generating elements different in length, when all the heat generating elements are disposed on the front surface, correspondingly to that many heat generating elements are disposed, a length of the heater 600 with respect to the recording material feeding direction becomes long. Then, a pressing force for forming the fixing nip N has to be made large. An increase in pressing force causes an increase in torque for rotationally driving the pressing roller 70 and is not preferable. Accordingly, by disposing the heat generating elements on each of the both surfaces of the substrate 610, a heater including many heat generating elements which are short in length with respect to the recording material feeding direction and which are for meeting various sizes is obtained.

Further, as regards the heat generating elements, input electric power for heating the fixing belt 650 to a predetermined temperature increases as a length of the heat generating element is longer (i.e., an area is larger). For this reason, longer heat generating elements are disposed close to the fixing belt 650, so that the input electric power for heating the fixing belt 650 to the predetermined temperature can be suppressed. Accordingly, in this embodiment, as described above, of the plurality of heat generating elements, the longer heat generating elements 623a-623c is disposed on the front surface of the substrate 610, and the shorter heat generating elements 623d-623f are disposed on the back surface of the substrate 610, respectively. By this, electric power saving is realized in the constitution in which the heat generating elements are provided on the both surfaces of the substrate 610.

Thus, electric power required for maintaining the temperature of the fixing belt 650 at the predetermined temperature is decreased, and therefore, electric power saving as the heater unit 680 becomes possible. Further, supply of heat in a larger amount from the heater 600 to the fixing belt 650 at the same electric power consumption becomes possible. Accordingly, without increasing the electric power supply (amount), a lowering in temperature of the fixing belt 650 when the recording material passes through the fixing nip N can be suppressed, so that it becomes possible that a lowering in productivity with the lowering in temperature of the fixing belt 650 is suppressed.

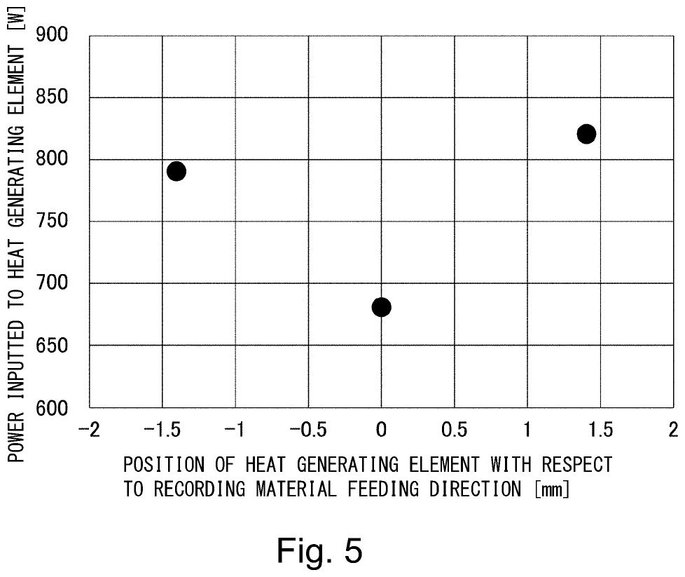

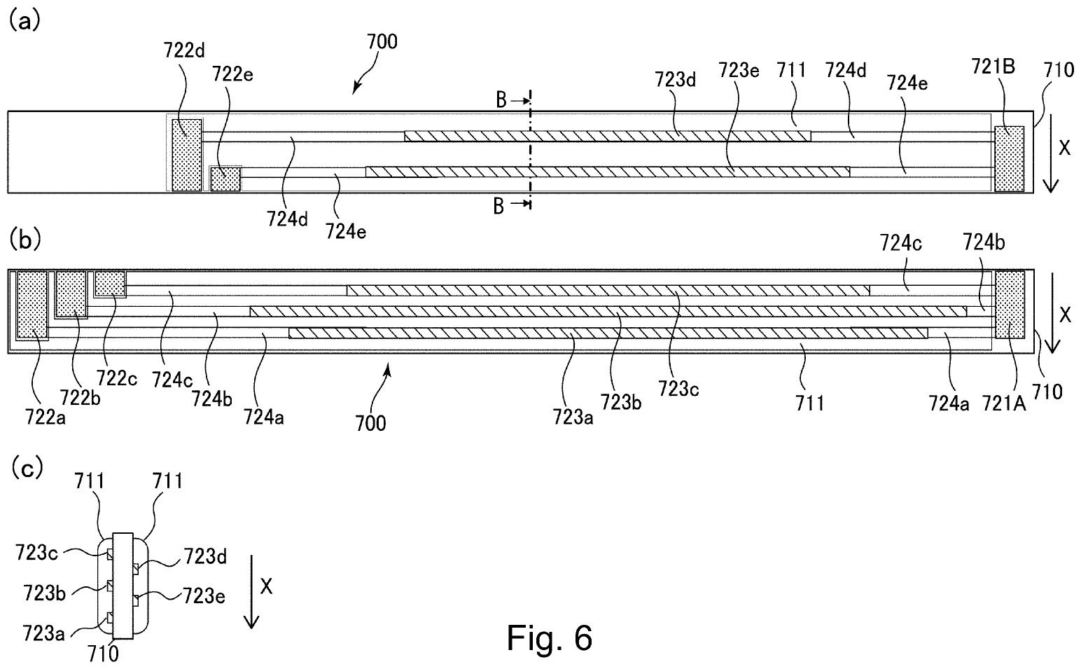

Next, the reason why the respective heat generating elements are disposed as described above on each of the surfaces of the substrate 610 will be described using FIG. 5. FIG. 5 shows a result of an investigation of a relationship between a position of the heat generating element with respect to the recording material feeding direction in the fixing nip N when A4 sheets are continuously passed through the fixing nip N and necessary electric power inputted to the heat generating element for maintaining the temperature of the fixing belt 650 at the predetermined temperature. In FIG. 5, in order to show a difference in input electric power due to an arrangement place of the heat generating elements, the cases where electric power of each of the heat generating elements is 1205 W equivalent to the electric power of the heat generating element 623b and where the heat generating elements are disposed on an upstream side, a central side, and a downstream side, respectively, are shown.

The abscissa of FIG. 5 shows the position of the heat generating element with respect to the recording material feeding direction in the fixing nip N, and 0 mm corresponds to the center side, a positive direction corresponds to the upstream side, and a negative direction corresponds to the downstream side. The recording material is fed from the upstream side toward the downstream side. The ordinate shows the electric power inputted to each of the heat generating elements required for maintaining the temperature of the fixing belt 650 at the predetermined temperature.

As shown in FIG. 5, the input electric power to the center heat generating element (position of 0 mm) was 680 W, the input electric power to the downstream heat generating element (position of the negative direction on the abscissa) was 790 W, and the input electric power to the upstream heat generating element (position of the positive direction on the abscissa) was 820 W. Heating efficiency is higher as the input electric power is smaller, and therefore, the heating efficiency becomes (central)>(downstream)>(upstream). Accordingly, it is understood that the heating efficiency can be made highest by disposing the heat generating element on the central side. This would be considered because the fixing nip N can be heated substantially uniformly from the central side toward the upstream side and the downstream side.

On the other hand, as shown in FIG. 2, the recording material S enters the fixing nip N from the downstream side and passes through the fixing nip N toward the upstream side (the recording material is fed from a right(-hand) side toward a left(-hand) side of FIG. 2). For this reason, compared with the upstream side, on the downstream side, a time in which the recording material S contacts the fixing belt 650 becomes long. Accordingly, when the heat generating element is disposed on the downstream side compared with the upstream side, the heating efficiency becomes high. From the above, highest heating efficiency can be obtained by disposing the heat generating element large in electric power of the heat generating element, i.e., the longest heat generating element with respect to the widthwise direction of the heat generating element, at the position where the heating efficiency is high. This holds not only on the front surface but also on the back surface.

In this embodiment, as described above, not only on the front surface but also on the back surface, the heat generating elements are disposed so that lengths thereof with respect to the widthwise direction satisfy (central)>(downstream)>(upstream) with respect to the recording material feeding direction, i.e., the rotational direction of the fixing belt 650. For this reason, in the constitution in which the plurality of heat generating elements are provided on the both surfaces of the substrate, it becomes possible to provide the heater with excellent heating efficiency.

### Second Embodiment

A second embodiment will be described using FIG. 6. In the above-described first embodiment, the constitution in which the three heat generating elements were provided on each of the both surfaces of the substrate was described. On the other hand, in this embodiment, three heat generating elements are provided on the front surface of a substrate 710, and two heat generating elements are provided on the back surface of the substrate 710. Other constitutions and actions are similar to those in the above-described first embodiment, and therefore, the same constitution portions will be omitted from illustration and description or will be briefly described, and a portion different from the first embodiment will be principally described.

Part (a) of FIG. 6 shows the back surface of the substrate 710 of the heater 700 in this embodiment, part (b) of FIG. 6 shows the front surface of the heater 700, and part (c) of FIG. 6 shows a B-B cross-sectional view of the heater 700. Arrows X in the figures indicate a rotational direction of the fixing belt 650 in the fixing nip N, i.e., a recording material feeding direction (see FIG. 2).

The heater 700 as a heating member includes a substrate 710 and a plurality of heat generating elements 723a-723e which are provided on both surfaces of the substrate 710 and which generate heat by energization, and heats the fixing belt 650 by being contacted to the inner peripheral surface of the fixing belt 650 (FIG. 2). The substrate 710 has an insulating property and a heat-resistant property, and is formed by using a material with a further high thermo-conductive property, for example, ceramic such as alumina or aluminum nitride.

The plurality of heat generating elements 723a-623e are different from each other in length with respect to the widthwise direction crossing the rotational direction of the fixing belt 650 in other to meet recording materials of the plurality of sizes. These respective heat generating elements 723a-723e are provided substantially parallel to the widthwise direction, respectively. Further, the heat generating elements 723a-723e are disposed with intervals with each other with respect to the recording material feeding direction on the respective surfaces thereof. Further, on the front surface (first surface) of the substrate 710 which is a side where the heater 700 contacts the inner peripheral surface of the fixing belt 650, a plurality (for example, at least three pieces) of heat generating elements are provided. In this embodiment, three heat generating elements 723a-723c are provided on the front surface of the substrate 710. On the other hand, on the back surface (second surface) of the substrate 710 which is a side opposite from the front surface of the substrate 710, at least one heat generating element is provided. In the embodiment, two heat generating elements 723d and 723e are provided on the back surface of the substrate 710. That is, in this embodiment, the number of the heat generating elements provided on the front surface in more than the number of the heat generating elements provided on the back surface.

As shown in part (a) of FIG. 6, on the back surface of the substrate 710, the two heat generating elements 723d and 723e different from each other in length with respect to the widthwise direction are printed and baked by using silver/palladium (Ag/Pd). Further, these heat generating elements 723d and 723e are connected to two independent electrodes 722d and 722e, respectively, on one end side with respect to the widthwise direction by electroconductive member patterns 723d and 724e formed of silver (Ag) or the like, and are connected to a single common electrode 721B on the other end side by the electroconductive member patterns 723d and 724e. These heat generating elements 723d and 723e and electroconductive member patterns 724d and 724e are covered with the protective glass 711 of, for example, 60-90 μm in thickness.

As shown in part (b) of FIG. 6, also on the front surface of the substrate 710, similarly as the back surface, the three heat generating elements 723a-723c different from each other in length with respect to the widthwise direction are printed and baked by using silver/palladium (Ag/Pd). Further, these heat generating elements 723a-723c are connected to three independent electrodes 722a-722c, respectively, on one end side with respect to the widthwise direction by electroconductive member patterns 723a-723c formed of silver (Ag) or the like, and are connected to a single common electrode 721A on the other end side by the electroconductive member patterns 723a-723c. These heat generating elements 723a-723c and electroconductive member patterns 724a-724c on the front surface are, similarly as the back surface, covered with the protective glass 711 of, for example, 60-90 μm in thickness.

Incidentally, also in the case of this embodiment, the common electrodes 721A and 721B are formed at the substantially same position with respect to the widthwise direction on both surfaces of the substrate 710. On the other hand, the independent electrodes 722a-722c and the independent electrodes 722d and 722e are formed at different positions with respect to the widthwise direction on both surfaces of the substrate 710. However, a positional relationship between the common electrodes 721A and 721B and a positional relationship between the independent electrodes 722a-722c and the independent electrodes 722d and 722e are not limited to these. Further, a control constitution of the heater 700 in this embodiment is a constitution similar to the control constitution of FIG. 3 in the first embodiment, in which only the number of the triacs and the number of the triac driving circuits are different from those in the first embodiment depending on the number of the heat generating elements.

Next, an arrangement of the plurality of heat generating elements 723a-723e will be described. Also, as regards the heater 700 of this embodiment, of the plurality of heat generating elements 723a-723f, the heat generating element 723b longest in length with respect to the widthwise direction is provided on the front surface. Further, the three heat generating elements 723a-723c provided on the front surface are the heat generating element 723b (first heat generating element), the heat generating element 723a (second heat generating element), and the heat generating element 723c (third heat generating element) in the order from the heat generating element with a longer length with respect to the widthwise direction. In this case, with respect to the rotational direction of the fixing belt 650, the longest heat generating element 723b with respect to the widthwise direction is disposed between the heat generating element 723a and the heat generating element 723c. Further, the heat generating elements 723a-723c are disposed in the order of the heat generating element 723c, the heat generating element 723b, and the heat generating element 723a from an upstream side to a downstream side with respect to the rotational direction of the fixing belt (from an upstream side to a downstream side with respect to a direction in which the recording material is fed in the fixing nip N, with respect to the arrow X direction).

On the other hand, the two heat generating elements 723d and 723e provided on the back surface are the heat generating element 723e, and the heat generating element 723d in the order from the heat generating element with a longer length with respect to the widthwise direction. In this case, with respect to the rotational direction of the fixing belt 650, the longer heat generating element 723e with respect to the widthwise direction is disposed on a side downstream of the heat generating element 723d.

Incidentally, lengths of the heat generating elements on each of the surfaces are the same with respect to the rotational direction of the fixing belt 650. In this embodiment, the lengths of all the heat generating elements 723a-723e with respect to the rotational direction of the fixing belt 650 are the same.

Further, also in the case of this embodiment, the length of the longest heat generating element 723e with respect to the widthwise direction provided on the back surface is shorter than the length of the shortest heat generating element 723c with respect to the widthwise direction provided on the front surface. That is, the lengths of all the heat generating elements with respect to the widthwise direction provided on the back surface is made shorter than the shortest heat generating element of the heat generating elements provided on the front surface. In other words, the heat generating elements are disposed on the front surface in the order from the longest heat generating element with respect to the widthwise direction. Specifically, the heat generating elements 723b, 723a and 723c which are long in the first, second and third are disposed on the front surface, and the heat generating elements 723e and 623d which are long in the fourth and fifth are disposed on the back surface.

Next, specific examples of the respective heat generating elements 723a-723f will be described. The five heat generating elements 723a-723e disposed on the both surfaces of the substrate 610 are different from each other in length, resistance value, and electric power in conformity with lengths of a plurality of sheets with respect to the widthwise direction. In a table 2, examples of the heat generating elements 723a-723e are shown. Incidentally, a “heat generating element length” in the table 2 is a length of the heat generating element with respect to the widthwise direction.

TABLE 2

| Surface | HGE*¹ | CSS*² | SW*³[mm] | HGEL*⁴[mm] |
|---|---|---|---|---|
| Front | 723b | A3/A4 | 297 | 318 |
| | 723a | LTR | 279.4 | 300.4 |
| | 723c | B4/B5 | 257 | 278 |
| Back | 723e | A4R/A5 | 210 | 231 |
| | 723d | B5R | 182 | 203 |

*¹“HGE” is the heat generating element.
*²“CSS” is a corresponding sheet size.
*³“SW” is a sheet width.
*⁴“HGEL” is a heat generating element length.

In such a case of this embodiment, in an area of the substrate 710, many heat generating elements to the extent possible are disposed on the front surface where heat conduction is good, and therefore, electric power necessary to control the temperature of the fixing belt is reduced, so that it becomes possible to realize energy saving.

Further, also in the case of this embodiment, electric power required for maintaining the temperature of the fixing belt 650 at the predetermined temperature is decreased, and therefore, electric power saving as the heater unit becomes possible. Further, supply of heat in a larger amount from the heater 700 to the fixing belt 650 at the same electric power consumption becomes possible. Accordingly, without increasing the electric power supply (amount), a lowering in temperature of the fixing belt 650 when the recording material passes through the fixing nip N can be suppressed, so that it becomes possible that a lowering in productivity with the lowering in temperature of the fixing belt 650 is suppressed.

Further, in the case of this embodiment, the longer heat generating element with respect to the widthwise direction is disposed on the front surface on the central side of the fixing nip N, and further, in the case where a most downstream heat generating element and a most upstream heat generating element are compared with each other on the both sides, the longer heat generating element with respect to the widthwise direction is disposed on the downstream side. For this reason, as described with reference to FIG. 5, in the constitution in which the plurality of heat generating elements are provided on the both surfaces of the substrate, it becomes possible to provide the heater with excellent heating efficiency.

### Third Embodiment

A third embodiment will be described using FIG. 7 to FIG. 10. In this embodiment, two heat generating elements are provided on the front surface of a substrate 710, and a single heat generating element is provided on the back surface of the substrate 710. Other constitutions and actions are similar to those in the above-described embodiments, and therefore, the same constitution portions will be omitted from illustration and description or will be briefly described, and a portion different from the above-described embodiments will be principally described.

### [Details of Heater]

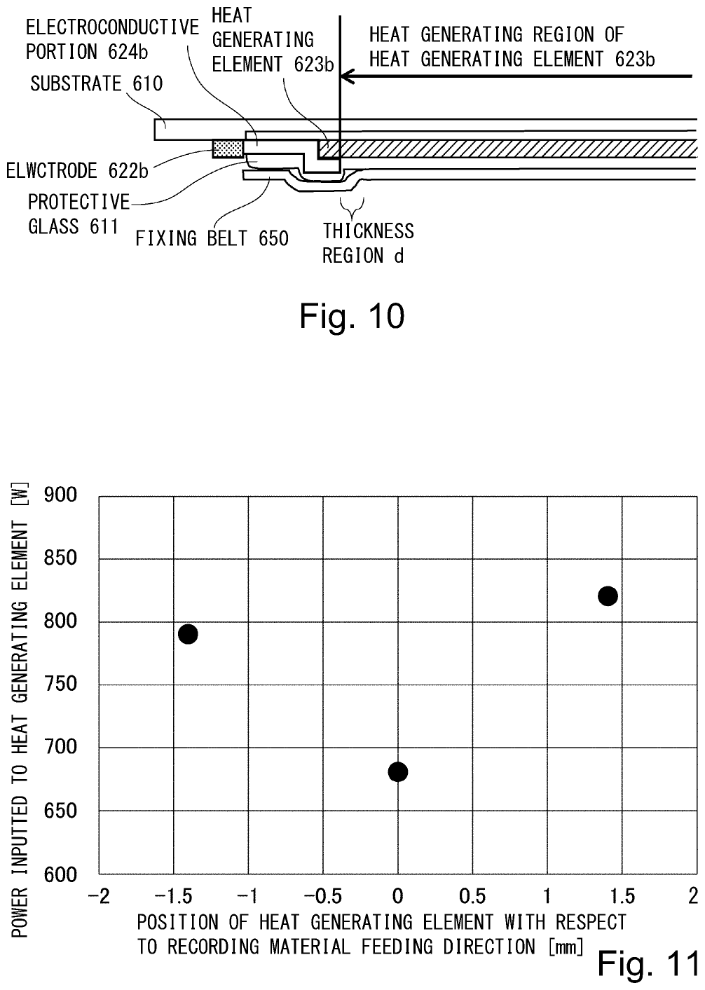

Next, details of the heater 600 of this embodiment will be described using part (a) of FIG. 8 to FIG. 10 while making reference to part (b) of FIG. 7. Part (a) of FIG. 8 shows a front surface side of the heater 600, part (b) of FIG. 8 shows a back surface (front face) side of the heater 600, and part (a) of FIG. 9 shows an A-A cross-sectional view of the heater 600 and the fixing belt 650. Part (b) of FIG. 9 and FIG. 10 are enlarged views of a left end portion side of part (a) of FIG. 9. Incidentally, in FIG. 10, heat generating elements on the back surface side and the like are omitted. Further, in part (b) of FIG. 7, parts (a) and (b) of FIG. 8, arrows X in the figures indicate a rotational direction of the fixing belt 650 in the fixing nip N, i.e., a recording material feeding direction.

The heater 600 as a heating member includes the substrate 610 and the plurality of heat generating elements 623a-623c which are provided on both surfaces of the substrate 610 and which generate heat by energization, and heats the fixing belt 650 by being contacted to the inner peripheral surface of the fixing belt 650. The substrate 610 has an insulating property and a heat-resistant property, and is formed by using a material with a further high thermo-conductive property, for example, ceramic such as alumina or aluminum nitride.

The plurality of heat generating elements 623a-623c are different from each other in length with respect to the widthwise direction crossing the rotational direction of the fixing belt 650 in other to meet recording materials of the plurality of sizes. These respective heat generating elements 623a-623c are provided substantially parallel to the widthwise direction, respectively. Further, the heat generating elements 623a and 623b are disposed with intervals with each other with respect to the recording material feeding direction. Further, on the front surface (first surface, surface A) of the substrate 610 which is a side where the heater 600 contacts the inner peripheral surface of the fixing belt 650, a plurality of heat generating elements are provided. In this embodiment, two heat generating elements 623a and 623b are provided on the front surface of the substrate 610. On the other hand, on the back surface (second surface, surface B) of the substrate 610 which is a side opposite from the front surface of the substrate 610, at least one heat generating element is provided. In this embodiment, the single heat generating element 623d is provided on the back surface of the substrate 610.

As shown in part (b) of FIG. 7 and part (a) of FIG. 8, on the front surface (surface A) of the substrate 610, similarly as the back surface, the two heat generating elements 623a and 623b different from each other in length with respect to the widthwise direction are printed and baked by using silver/palladium (Ag/Pd). Further, these heat generating elements 623a and 623b are connected to three independent electrodes 622a-622e, respectively, on one end side with respect to the widthwise direction by electroconductive member patterns (electroconductive portions) 624a-624c formed of silver (Ag) or the like, and are connected to a single common electrode 621A on the other end side by the electroconductive member patterns 624a and 624b. In this embodiment, of the plurality of heat generating elements 623a-623c provided on the substrate 610, the heat generating element 623a is longest, and the heat generating element 623b is secondarily longest. These heat generating elements 623a and 623b, and the electroconductive member patterns 624a and 624b are, as shown in part (b) of FIG. 7, covered with the protective glass (glass protective layer) 611 of, for example, 60-90 μm in thickness.

As shown in part (b) of FIG. 7 and part (b) of FIG. 8, also on the back surface (surface B) of the substrate 810, similarly as the front surface, a single heat generating element 623c is printed and baked by using silver/palladium (Ag/Pd) or the like. Further, by the electroconductive member pattern (electroconductive portion) 624c formed of silver (Ag) or the like, the heating efficiency 623c is connected to the electrode 622c on one end side with respect to the widthwise direction, and is connected to the electrode 621B on the other end side. In this embodiment, of the plurality of heat generating elements 623a-623c provided on the substrate 610, the heat generating element 623c is shortest. Also, the heat generating element 623c and the electroconductive member pattern 624c on the back surface are, similarly as the front surface, as shown in part (b) of FIG. 7, covered with the protective glass (glass protective layer) 611 of, for example, 60-90 μm in thickness.

Incidentally, in the case of this embodiment, the common electrodes 621A and 621B are formed at the substantially same position with respect to the widthwise direction on both surfaces of the substrate 610. On the other hand, the independent electrodes 622a-622c and the independent electrodes 622d-622f are formed at different positions with respect to the widthwise direction on both surfaces of the substrate 610. However, a positional relationship between the common electrodes 621A and 621B and a positional relationship between the independent electrodes 622a-622c and the independent electrodes 622d-622d are not limited to these.

### [Connecting Portion of Heat Generating Element and Electroconductive Member Pattern]

Here, a connecting portion of the heat generating element and the electroconductive member pattern will be described using FIG. 10. FIG. 10 is a sectional view of the connecting portion of the heat generating element 623b and the electroconductive member pattern 624b in the heater 600 with respect to the longitudinal direction (widthwise direction). In FIG. 10, as a representative, the connecting portion of the heat generating element 623b and the electroconductive member pattern (electroconductive portion) 624b will be described, but a connecting portion of another heat generating element and another electroconductive member pattern are also similar to the above-described connecting portion. As described above, the heater 600 includes, on the substrate 610, the heat generating element 623b and the electroconductive member pattern (electroconductive portion) 624b connecting the heat generating element 623b and the electrode 622b which is an energizing portion. The connecting portion connecting these heat generating element 623b and electroconductive member pattern 624b is formed on the substrate 610 in an overlapping state with respect to a thickness direction (direction perpendicular to the front surface of the substrate 610), whereby energization is stably established from the electroconductive member pattern 624b toward the heat generating element 623b. Incidentally, the electrode 621A side is also similar to this side.

However, as shown in FIG. 10, in the connecting portion, a part of the heat generating element 623b and a part of the electroconductive member pattern 624b are caused to overlap with each other with respect to the thickness direction, whereby the connecting portion becomes partially thick. Hereinafter, a region in which the connecting portion thus become partially thick is referred to as a region d.

As described above, the plurality of heat generating elements provided on the heater 600 are also different in heat generating region with respect to the widthwise direction because lengths thereof with respect to the widthwise direction are different from each other. Incidentally, a length of the heat generating region with respect to the widthwise direction (heat generating region length) is substantially a length of the heat generating element with respect to the widthwise direction. On the other hand, in the fixing device, there is an image guarantee region depending on a kind thereof. The image guarantee region is a region in which it is guaranteed that the toner image on the recording material passed through the fixing nip N can be normally fixed. Specifically, a range not less than a length, with respect to the widthwise direction, of a maximum size recording material capable of passing through the fixing nip N is the image guarantee region. In this embodiment, a range which is longer than the length, with respect to the widthwise direction, of the maximum size recording material capable of passing through the fixing nip N, by 2 mm in total by adding 1 mm to the length on each of both sides with respect to the widthwise direction. For example, in the case where the maximum size recording material is an A4 in size, a length of the A4 with respect to the widthwise direction is 297 mm, and therefore, the image guarantee region becomes 299 mm.

Accordingly, in the case where the plurality of heat generating elements different in length with respect to the widthwise direction are provided on a single substrate so as to meet sizes of recording materials with a plurality of sizes, there is a possibility that the connecting portion of the heat generating element and the electroconductive member pattern is positioned within the image guarantee region. Further, in the case where the plurality of heat generating elements exist on the front surface side of the substrate 610, i.e., on the fixing nip N side, the connecting portion of the heat generating element and the electroconductive member pattern is provided within the image guarantee region and within the contact portion of the fixing belt 650 and the heater 600 in some cases. In this case, the thickness region d prevents contact between the heater 600 and the fixing belt 650 and impairs heat conduction from the heater 600 toward the fixing belt 650. As a result, a region of the connecting portion causes temperature non-uniformity for the fixing belt 650 with respect to the longitudinal direction, and the temperature non-uniformity becomes an image defect such as uneven glossiness in some instances.

For example, it is assumed that among the heat generating elements having a plurality of lengths provided on the substrate 610, the shortest heat generating element 623c and the longest heat generating element 623a are disposed on the surface A (front surface) contacting the fixing belt 650. In this case, the image guarantee region is determined on the basis of the recording material corresponding to the longest heat generating element 623a, and therefore, the thickness region d of the shortest heat generating element 623c enters an inside of the image guarantee region. As a result, the heat conduction from the heater 600 toward the fixing belt 650 in the case where the longest heat generating element 623a is used is impaired in the thickness region d, and becomes a factor of the image defect.

Incidentally, even if the thickness region d of the connecting portion is within the image guarantee region, when the thickness region d exists outside the length, with respect to the widthwise direction, of the maximum size recording material capable of passing through the fixing nip N, the above-described image defect does not readily occur.

Therefore, in this embodiment, all the heat generating elements 623a and 623b provided on the front surface (surface A) are made longer in length with respect to the widthwise direction than the maximum size recording material capable of passing through the fixing nip N. By this, the connecting portions of all the heat generating elements 623a and 623b on the front surface with the electroconductive member patterns 624a and 624b are positioned outside the maximum size recording material with respect to the widthwise direction. Further, all the heat generating element 623c provided on the back surface (surface B) are mad shorter in length with respect to the widthwise direction than the length of the maximum size recording material with respect to the widthwise direction. In other words, the heat generating element shorter in length with respect to the widthwise direction than the length with respect to the widthwise direction, of the maximum size recording material is disposed on the back surface on the side opposite from the fixing nip N. The back surface is a surface on a side where the back surface does not contact the fixing belt 650, and even when the above-described connecting portion is positioned inside the maximum size recording material with respect to the widthwise direction, an occurrence of the image defect due to the temperature non-uniformity can be suppressed.

Incidentally, it is preferable that all the heat generating elements 623a and 623b provided on the front surface (surface A) is made longer in length with respect to the widthwise direction than the length, with respect to the widthwise direction, of the above-described image guarantee region and the connecting portion is prevented from existing within the image guarantee region. Further, all the heat generating element 623c provided on the back surface (surface B) may also be made longer than the length, with respect to the widthwise direction, of the maximum size recording material if the length thereof with respect to the widthwise direction is smaller than the length in the image guarantee region with respect to the widthwise direction.

### [Arrangement of Respective Heat Generating Elements]

Next, an arrangement of the plurality of heat generating elements 623a-623c will be described specifically using part (a) of FIG. 8 to part (b) of FIG. 9. As regards the heater 600 of this embodiment, of the plurality of heat generating elements 623a-623c, the heat generating element 623a longest in length with respect to the widthwise direction is provided on the front surface of the substrate 610 contacts the fixing belt 650. Further, the two heat generating elements 623a and 623b provided on the front surface are, the heat generating element 623a (sixth heat generating element) and the heat generating element 623b (seventh heat generating element) in the order from the heat generating element with a longer length with respect to the widthwise direction. In this case, with respect to the rotational direction of the fixing belt 650, direction in which the recording material is fed in the fixing nip N, with respect to the arrow X direction, the longer heat generating element 623a with respect to the widthwise direction is disposed on a side downstream of the heat generating element 623b. On the other hand, on the back surface of the substrate 610, at least one heat generating element 623c is provided.

That is, in this embodiment, on the front surface, in the case where the heat generating element on the upstream side and the heat generating element on the downstream side are compared with each other, the heat generating element on the downstream side is made longer in length with respect to the widthwise direction than the heat generating element on the upstream side. Incidentally, in this embodiment, the number of the heat generating element on the back surface is one, but in the case where a plurality of heat generating elements are provided, similarly as the front surface, the heat generating element on the downstream side is made longer in length with respect to the widthwise direction. Further, lengths of the heat generating elements on each of the surfaces are the same with respect to the rotational direction of the fixing belt 650. In this embodiment, the lengths of all the heat generating elements 623a-623c with respect to the rotational direction of the fixing belt 650 are the same.

Particularly, in the case of this embodiment, as described above, the lengths, with respect to the widthwise direction, of all the heat generating elements 623a and 623b provided on the back surface front surface (surface arrow) are made longer than the length, with respect to the widthwise direction, of the maximum size recording material capable of passing through the fixing nip N. Further, the length, with respect to the widthwise direction, of all the heat generating element 623c provided on the back surface (surface B) is made shorter than the length, with respect to the widthwise direction, of the maximum size recording material. Specifically, the heat generating elements 623a and 623b which are long in the first and second are disposed on the front surface, and the shortest heat generating element 623c is disposed, on the back surface.

Description will be specifically made using parts (a) and (b) of FIG. 9. Part (a) of FIG. 9 is a sectional view of the heater 600 cut along A-A of part (b) of FIG. 7, and is a schematic view showing a positional relationship of the heater 600 and the fixing belt 650. Part (b) of FIG. 9 is an enlarged view of a let side portion of part (a) of FIG. 9. A region which is a region obtained by removing the thickness region d from the heat generating region of the heat generating element and such that the surface of the protective glass 611 becomes flat is called a flat region. In this embodiment, in order to suppress the image defect due to the thickness region d of the heat generating element disposed on the surface A side, a length of a minimum length heat generating element in the flat region disposed on the surface A is made not less than a length (299 mm) of the fixing device 30 in the image guarantee region in this embodiment.

As shown in part (b) of FIG. 9, the fixing belt 650 is on the protective glass 611 covering the connecting portion where the electroconductive member pattern 624b and the heat generating element 623b overlap with each other. In this case, by the thickness and rigidity of the fixing belt 650, in a region (thickness region d) of 0.5 mm inside from an end portion of the heat generating region of the heat generating element 623b, the fixing belt 650 has a shape such that the fixing belt 650 extends along a partial thickness of the protective glass 611. As a result, heat conduction from the heat generating element 623b toward the fixing belt 650 in the region is impaired, and becomes a factor of the image defect.

For that reason, in order to suppress the image defect, it is preferable that this thickness region d does not enter the image guarantee region. In order to dispose the thickness region d of 0.5 mm in length outside the image guarantee region of 299 mm, it is required that the heat generating region length of the minimum heat generating element disposed on the surface A of the substrate 610 is longer than 299 mm. In this embodiment, a constitution such that the heat generating element 623b which is 300.4 mm in heat generating region length becomes a minimum heat generating element disposed on the surface A of the substrate 610 is employed, so that a constitution in which the image defect can be suppressed by satisfying the above-described condition is employed.

Incidentally, in this embodiment, a heater constitution in which the three heat generating elements different in length was described, but is not limited to this, and a constitution in which the number of all the heat generating elements and distribution of the heat generating elements on the front and back surfaces are different may also be employed. For example, the constitution may also be a constitution such that the number of heat generating elements is a plurality of pieces such as one piece on the surface A and two pieces on the surface B. That is, a heat generating element longer than a length of the maximum size recording material with respect to the widthwise direction may be disposed on the surface A, and a plurality of heat generating elements shorter than the length of the maximum size recording material with respect to the widthwise direction may also be disposed on the surface B. Or, a constitution in which two or more heat generating elements and four or more heat generating elements are disposed on the surface A and the surface B, respectively may also be employed. In summary, when the heat generating element disposed on the surface A is longer than the length of the maximum size recording material with respect to the widthwise direction and the heat generating element on the surface B is shorter than the length of the maximum size recording material with respect to the widthwise direction, the number of the heat generating elements disposed on each of the surfaces may also be any number.

Next, specific examples of the respective heat generating elements 623a-623c will be described. The three heat generating elements 623a-623c disposed on the both surfaces of the substrate 610 are different from each other in length, resistance value, and electric power in conformity with lengths of a plurality of sheets with respect to the widthwise direction. In a table 3, examples of the heat generating elements 623a-623c are shown. Incidentally, a “heat generating region length” in the table 3 shows a length of the heat generating element with respect to the widthwise direction, and a sheet size shows a length of the sheet with respect to the widthwise direction.

TABLE 3

| HGE*¹ | HGRL*² (mm) | CSN*³ | SS*⁴ (mm) |
|---|---|---|---|
| 623a | 318 | A4 | 297 |
| 623b | 300.4 | LTR | 279.4 |
| 623c | 160.7 | STMTR | 139.7 |

*¹“HGE” is the heat generating element.
*²“HGRL” is the heat generating region length.
*³“CSN” is a corresponding sheet name.
*⁴“SS” is a sheet size.

As shown in the table 3, the lengths of the heat generating elements (heat generating region lengths) are larger than corresponding recording material sizes, respectively, and specifically, are so as to be 21 mm longer than the recording material size (sheet size). This is because it is considered that an end portion temperature lowers due to the heat conduction in the longitudinal direction 8widthwise direction) when the heat generating element is caused to generate heat and that heat generation of the region in which the recording material does not pass is suppressed when the recording materials are continuously passed through the fixing nip N.

As is apparent from the table 3, the heat generating element 623c having a heat generating region length shorter than 299 mm which is the length of the image guarantee region of the fixing device 30 in this embodiment is disposed on the surface B side where the heat generating element 623c does not directly contact the fixing belt 650. By this, it is possible to prevent the image defect generated by the above-described partial thickness of the connecting portion of the heat generating element and the electroconductive member pattern.

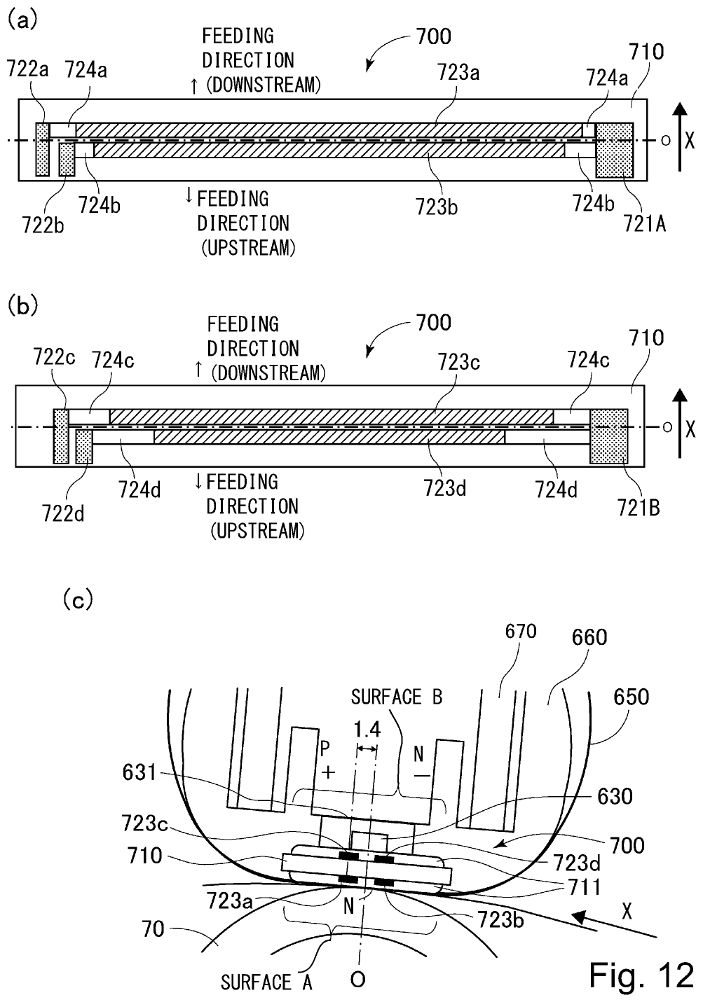

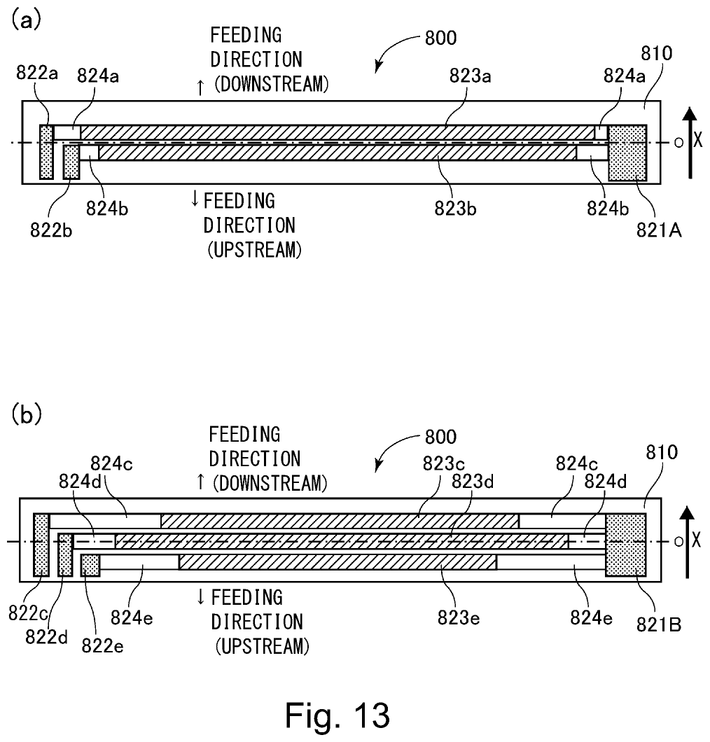

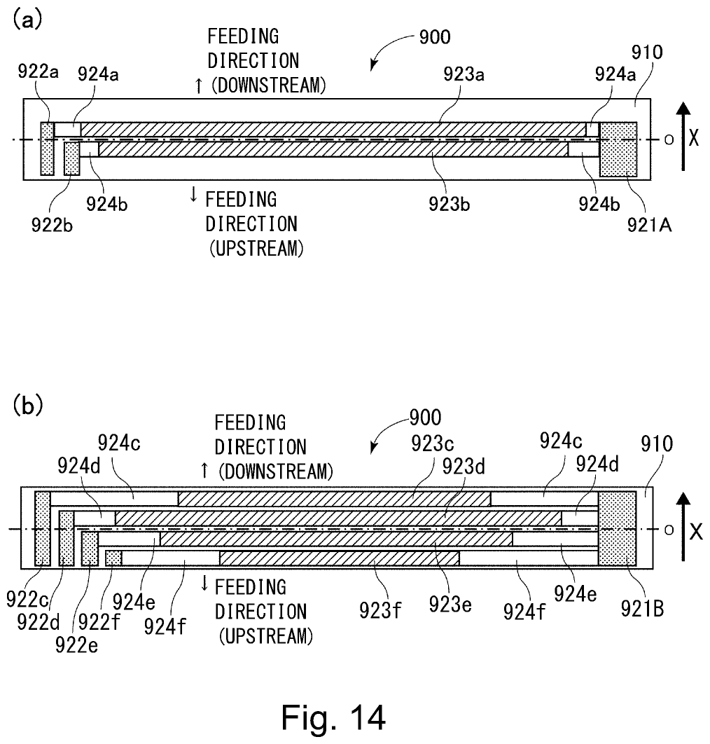

Next, the reason why the respective heat generating elements are disposed as described above on the front surface of the substrate 610 will be described using FIG. 11. FIG. 11 shows a result of an investigation of a relationship between a position of the heat generating element with respect to the recording material feeding direction in the fixing nip N when A4 sheets are continuously passed through the fixing nip N and necessary electric power inputted to the heat generating element for maintaining the temperature of the fixing belt 650 at the predetermined temperature. In FIG. 11, in order to show a difference in input electric power due to an arrangement place of the heat generating elements, the cases where electric power of each of the heat generating elements is 1205 W equivalent to the electric power of the heat generating element 623b and where the heat generating elements are disposed on an upstream side, a central side, and a downstream side, respectively, are shown.

The abscissa of FIG. 11 shows the position of the heat generating element with respect to the recording material feeding direction in the fixing nip N, and 0 mm corresponds to the center side, a positive direction corresponds to the upstream side, and a negative direction corresponds to the downstream side. The recording material is fed from the upstream side toward the downstream side. The ordinate shows the electric power inputted to each of the heat generating elements required for maintaining the temperature of the fixing belt 650 at the predetermined temperature.

As shown in FIG. 11, the input electric power to the center heat generating element (position of 0 mm) was 680 W, the input electric power to the downstream heat generating element (position of the negative direction on the abscissa) was 790 W, and the input electric power to the upstream heat generating element (position of the positive direction on the abscissa) was 820 W. Heating efficiency is higher as the input electric power is smaller, and therefore, the heating efficiency becomes (central)>(downstream)>(upstream). Accordingly, it is understood that the heating efficiency can be made highest by disposing the heat generating element on the central side. This would be considered because the fixing nip N can be heated substantially uniformly from the central side toward the upstream side and the downstream side.

On the other hand, as shown in parts (a) and (b) of FIG. 7, the recording material S enters the fixing nip N from the downstream side and passes through the fixing nip N toward the upstream side (the recording material is fed from a right(-hand) side toward a left(-hand) side of parts (a) and (b) of FIG. 7). For this reason, compared with the upstream side, on the downstream side, a time in which the recording material S contacts the fixing belt 650 becomes long. Accordingly, when the heat generating element is disposed on the downstream side compared with the upstream side, the heating efficiency becomes high. From the above, highest heating efficiency can be obtained by disposing the heat generating element large in electric power of the heat generating element, i.e., the longest heat generating element with respect to the widthwise direction of the heat generating element, at the position where the heating efficiency is high. This holds not only on the front surface but also on the back surface.

In this embodiment, as described above, on the front surface, the heat generating elements are disposed so that lengths thereof with respect to the widthwise direction satisfy (downstream)>(upstream) with respect to the recording material feeding direction, i.e., the rotational direction of the fixing belt 650. For this reason, in the constitution in which the plurality of heat generating elements are provided on the both surfaces of the substrate, it becomes possible to provide the heater with excellent heating efficiency.

### Fourth Embodiment

A fourth embodiment will be described using parts (a) and (c) of FIG. 12. In the above-described third embodiment, the constitution in which the two heat generating elements were provided on the front surface of the substrate and the single heat generating element was provided on the back surface of the substrate was described. On the other hand, in this embodiment, two heat generating elements are also provided on the front surface of a substrate 710, and two heat generating elements are provided on the back surface of the substrate 710. Other constitutions and actions are similar to those in the above-described first embodiment, and therefore, the same constitution portions will be omitted from illustration and description or will be briefly described, and a portion different from the third embodiment will be principally described.

Part (a) of FIG. 12 shows a front surface (surface arrow) of the substrate 710 of the heater 700 in this embodiment, part (b) of FIG. 12 shows a back surface (surface B) of the substrate 710, and part (c) of FIG. 12 shows a view similar to part (b) of FIG. 7. Arrows X in the figures indicate a rotational direction of the fixing belt 650 in the fixing nip N, i.e., a recording material feeding direction.

The heater 700 as a heating member includes the substrate 710 and the plurality of heat generating elements 723a-723d which are provided on both surfaces of the substrate 710 and which generate heat by energization, and heats the fixing belt 650 by being contacted to the inner peripheral surface of the fixing belt 650. The substrate 610 has an insulating property and a heat-resistant property, and is formed by using a material with a further high thermo-conductive property, for example, ceramic such as alumina or aluminum nitride.

The plurality of heat generating elements 723a-723d are different from each other in length with respect to the widthwise direction crossing the rotational direction of the fixing belt 650 in other to meet recording materials of the plurality of sizes. These respective heat generating elements 723a-723d are provided substantially parallel to the widthwise direction, respectively. Further, the heat generating elements 723a-723d are disposed with intervals with each other with respect to the recording material feeding direction on the respective surfaces thereof. Further, on the front surface (first surface, surface arrow) of the substrate 710 which is a side where the heater 600 contacts the inner peripheral surface of the fixing belt 650, a plurality of heat generating elements are provided. In this embodiment, two heat generating elements 723a and 723b are provided on the front surface of the substrate 710. On the other hand, on the back surface (second surface, surface belt) of the substrate 710 which is a side opposite from the front surface of the substrate 710, at least one heat generating element is provided. In this embodiment, two heat generating elements 723c and 723d are provided on the back surface of the substrate 710. That is, in this embodiment, the number of the heat generating elements provided on the front surface is the same as the number of the heat generating elements provided on the back surface.

As shown in part (a) of FIG. 12, on the front surface of the substrate 710, the two heat generating elements 723a and 723b different from each other in length with respect to the widthwise direction are printed and baked by using silver/palladium (Ag/Pd). Further, these heat generating elements 723a and 723b are connected to two independent electrodes 722a and 722b, respectively, on one end side with respect to the widthwise direction by electroconductive member patterns 723a and 723b formed of silver (Ag) or the like, and are connected to a single common electrode 721A on the other end side by the electroconductive member patterns 723a and 723b. These heat generating elements 723a and 723b and electroconductive member patterns 724a and 724b are covered with the protective glass 711 of, for example, 60-90 μm in thickness.

As shown in part (b) of FIG. 12, also on the back surface of the substrate 610, similarly as the front surface, the two heat generating elements 623c and 623d different from each other in length with respect to the widthwise direction are printed and baked by using silver/palladium (Ag/Pd). Further, these heat generating elements 723c and 723d are connected to two independent electrodes 722c and 722d, respectively, on one end side with respect to the widthwise direction by electroconductive member patterns 724c and 724d formed of silver (Ag) or the like, and are connected to a single common electrode 721B on the other end side by the electroconductive member patterns 724c and 724d. These heat generating elements 723c and 723d and electroconductive member patterns 724c and 724d on the front surface are, similarly as the front surface, covered with the protective glass 711 of, for example, 60-90 μm in thickness.

Incidentally, also, in the case of this embodiment, the common electrodes 721A and 721B are formed at the substantially same position with respect to the widthwise direction on both surfaces of the substrate 710. On the other hand, the independent electrodes 722a and 722b and the independent electrodes 722c and 722d are formed at different positions with respect to the widthwise direction on both surfaces of the substrate 710. However, a positional relationship between the common electrodes 721A and 721B and a positional relationship between the independent electrodes 722a and 722b and the independent electrodes 722c and 722b are not limited to these.

Next, an arrangement of the plurality of heat generating elements 723a-723d will be described. Also, as regards the heater 700 of this embodiment, of the plurality of heat generating elements 723a-723d, the heat generating element 723a longest in length with respect to the widthwise direction is provided on the front surface of the substrate 710, Further, the two heat generating elements 723a and 723b provided on the front surface are, the heat generating element 723a (sixth heat generating element) and the heat generating element 723b (seventh heat generating element) in the order from the heat generating element with a longer length with respect to the widthwise direction. In this case, with respect to the rotational direction of the fixing belt 650 (direction in which the recording material is fed in the fixing nip N, with respect to the arrow X direction), the longer heat generating element 723a in length with respect to the widthwise direction is disposed downstream of the heat generating element 723a.

On the other hand, the two heat generating elements 723ac and 723d provided on the back surface are the heat generating element 723c (fourth heat generating element) and the heat generating element 723d (fifth heat generating element) in the order from the heat generating element with a longer length with respect to the widthwise direction. In this case, with respect to the rotational direction of the fixing belt 650, the longer heat generating element 723c in length with respect to the widthwise direction is disposed downstream of the heat generating element 723d.

Incidentally, lengths of the heat generating elements on each of the surfaces are the same with respect to the rotational direction of the fixing belt 650. In this embodiment, the lengths of all the heat generating elements 723a-723d with respect to the rotational direction of the fixing belt 650 are the same.

Further, also in the case of this embodiment, all the heat generating elements 723a and 723b provided on front surface (surface A) are made longer in length with respect to the widthwise direction than the length, with respect to the widthwise direction, of the maximum size recording material capable provided on the back surface is made of passing through the fixing nip N. Further, all the heat generating elements provided on the back surface (surface B) are made shorter in length, with respect to the widthwise direction, of the maximum size recording material. Specifically, the heat generating elements 723a and 723b which are long in the first and second are disposed on the front surface, and the heat generating elements 723c and 723d which are long in the third and fourth are disposed on the back surface.

Incidentally, it is preferable that all the heat generating elements 723a and 723b provided on the front surface (surface A) are made longer in length with respect to the widthwise direction than the length of the image guarantee region with respect to the widthwise direction and the connecting portion is prevented from existing within the image guarantee region. Further, when all the heat generating elements 723c and 723d provided on the back surface (surface B) are smaller in length with respect to the widthwise direction than the length of the image guarantee region with respect to the widthwise direction, the length may also be made longer than the length of the maximum size recording material with respect to the widthwise direction.

Here, as shown in FIG. 11, in order to maintain the temperature of the fixing belt 650 at the predetermined temperature, in the case where the heat generating element 723a is disposed at a position of −1.4 mm (downstream) with respect to the feeding direction, an input electric power of 790 W is needed. Similarly, in the case where the heat generating element 723a is disposed at a position of 0 mm (center) with respect to the feeding direction, an input electric power of 680 W is needed, and in the case where the heat generating element 723a is disposed at a position of +1.4 mm (upstream) with respect to the feeding direction, an input electric power of 820 W is needed. Heating efficiency is higher with a smaller input electric power, and therefore, the heating efficiency depending on the position of the heat generating element is 0 mm (center)>−1.4 mm (downstream)>+1.4 mm (upstream).

In the case where the heat generating elements with a plurality of lengths are provided on the same surface of the heater 700, it is possible to obtain highest heat generating efficiency by disposing the heat generating element of which necessary input electric power is large, i.e., of which heat generating region length is long, at a position where the heating efficiency is high. In this embodiment, as shown in parts (a) and (b) of FIG. 12, on both surfaces of the heater 700, two heat generating elements are disposed so that the longer heat generating element is positioned on the downstream side with respect to a center of the feeding direction, so that compared with the case where the longer heat generating element is positioned on the upstream side, a constitution in which the heat generating efficiency is high is realized.

Next, specific examples of the respective heat generating elements 723a-723d will be described. The four heat generating elements 723a-723f disposed on the both surfaces of the substrate 710 are different from each other in length, resistance value, and electric power in conformity with lengths of a plurality of sheets with respect to the widthwise direction. In a table 4, examples of the heat generating elements 723a-723f are shown. Incidentally, a heat generating region in the table 4 shows a length of the heat generating element with respect to the widthwise direction, and a sheet size shows a length of the sheet with respect to the widthwise direction.

TABLE 4

| HGE*¹ | HGRL*² (mm) | CSN*³ | SS*⁴ (mm) |
|---|---|---|---|
| 723a | 318 | A4 | 297 |
| 723b | 300.4 | LTR | 279.4 |
| 723c | 278 | B4 | 257 |
| 723d | 224.2 | G_LTR_R | 203.2 |

*¹“HGE” is the heat generating element.
*²“HGRL” is the heat generating region length.
*³“CSN” is a corresponding sheet name.
*⁴“SS” is a sheet size.

As shown in the table 4, the lengths of the heat generating elements (heat generating region lengths) are larger than corresponding recording material sizes, respectively, and specifically, are so as to be 21 mm longer than the recording material size (sheet size).

As is apparent from the table 4, the heat generating element 623c having a heat generating region length shorter than 299 mm which is the length of the image guarantee region of the fixing device 30 in this embodiment is disposed on the surface B side where the heat generating elements 723c and 723d do not directly contact the fixing belt 650. By this, it is possible to suppress the image defect generated by the above-described partial thickness of the connecting portion of the heat generating element and the electroconductive member pattern.

In the case where the fixing belt is heated up to the predetermined temperature by using the plurality of heat generating elements different in heat generating region length, the necessary input electric power becomes larger with a longer heat generating element in heat generating region length. For that reason, in the case where the heat generating elements with the plurality of lengths are provided on the single heater as in this embodiment, it is preferable that the longer heat generating element in heat generating region length is disposed at the position where the heating efficiency for the fixing belt 650 becomes high.

### Fifth Embodiment

A fifth embodiment will be described using parts (a) and (b) of FIG. 13. In the above-described fourth embodiment, the constitution in which the three heat generating elements were provided on each of the both surfaces of the substrate was described. On the other hand, in this embodiment, two heat generating elements are provided on the front surface of a substrate 810, and three heat generating elements are provided on the back surface of the substrate 810. Other constitutions and actions are similar to those in the above-described third and fourth embodiments, and therefore, the same constitution portions will be omitted from illustration and description or will be briefly described, and a portion different from the third and fourth embodiments will be principally described.

Part (a) of FIG. 13 shows a front surface of a substrate 810 of the heater 800 in this embodiment, and part (b) of FIG. 13 shows a back surface of the substrate 810. Arrows X in the figures indicate a rotational direction of the fixing belt 650 (parts (a) and (b) of FIG. 7) in the fixing nip N, i.e., a recording material feeding direction (see FIG. 2).

The heater 800 as a heating member includes the substrate 810 and the plurality of heat generating elements 823a-823e which are provided on both surfaces of the substrate 810 and which generate heat by energization, and heats the fixing belt 650 by being contacted to the inner peripheral surface of the fixing belt 650. The substrate 610 has an insulating property and a heat-resistant property, and is formed by using a material with a further high thermo-conductive property, for example, ceramic such as alumina or aluminum nitride.

The plurality of heat generating elements 823a-823e are different from each other in length with respect to the widthwise direction crossing the rotational direction of the fixing belt 650 in other to meet recording materials of the plurality of sizes. These respective heat generating elements 823a-823e are provided substantially parallel to the widthwise direction, respectively. Further, the heat generating elements 823a-823e are disposed with intervals with each other with respect to the recording material feeding direction on the respective surfaces thereof. Further, on the front surface (first surface) of the substrate 810 which is a side where the heater 800 contacts the inner peripheral surface of the fixing belt 650, a plurality of heat generating elements are provided. In this embodiment, two heat generating elements 823a and 823b are provided on the front surface of the substrate 810. On the other hand, on the back surface (second surface) of the substrate 810 which is a side opposite from the front surface of the substrate 810, at least one heat generating element is provided. In this embodiment, three heat generating elements 823d-823e are provided on the back surface of the substrate 810. That is, in this embodiment, the number of the heat generating elements provided on the back surface is more than the number of heat generating elements provided on the front surface.

As shown in part (a) of FIG. 13, on the back surface of the substrate 810, the two heat generating elements 823a and 623b different from each other in length with respect to the widthwise direction are printed and baked by using silver/palladium (Ag/Pd). Further, these heat generating elements 823a and 823b are connected to two independent electrodes 822a and 822b, respectively, on one end side with respect to the widthwise direction by electroconductive member patterns 824a and 824b formed of silver (Ag) or the like, and are connected to a single common electrode 821A on the other end side by the electroconductive member patterns 824a and 824b. These heat generating elements 823a and 823b and electroconductive member patterns 824a and 824b are covered with a protective glass of, for example, 60-90 μm in thickness.

As shown in part (b) of FIG. 13, also on the back surface of the substrate 810, similarly as the front surface, the three heat generating elements 823c and 823e different from each other in length with respect to the widthwise direction are printed and baked by using silver/palladium (Ag/Pd). Further, these heat generating elements 823c-823e are connected to three independent electrodes 822c-822e, respectively, on one end side with respect to the widthwise direction by electroconductive member patterns 824c-824e formed of silver (Ag) or the like, and are connected to a single common electrode 821B on the other end side by the electroconductive member patterns 824c-824e. These heat generating elements 823c-823e and electroconductive member patterns 824c-824e on the front surface are, similarly as the front surface, covered with the protective glass of, for example, 60-90 μm in thickness.

Incidentally, also in the case of this embodiment, the common electrodes 821A and 821B are formed at the substantially same position with respect to the widthwise direction on both surfaces of the substrate 810. On the other hand, the independent electrodes 822a and 822b and the independent electrodes 822c-822e are formed at different positions with respect to the widthwise direction on both surfaces of the substrate 810. However, a positional relationship between the common electrodes 821A and 821B and a positional relationship between the independent electrodes 822a and 822b and the independent electrodes 822c-822e are not limited to these.

Next, an arrangement of the plurality of heat generating elements 823a-823e will be described. Also, as regards the heater 800 of this embodiment, of the plurality of heat generating elements 823a-823e, the heat generating element 823a longest in length with respect to the widthwise direction is provided on the front surface of the substrate 810. Further, the two heat generating elements 823a and 623b provided on the front surface are, the heat generating element 823a (sixth heat generating element) and the heat generating element 823b (seventh heat generating element) in the order from the heat generating element with a longer length with respect to the widthwise direction. In this case, with respect to the rotational direction of the fixing belt 650 (direction in which the recording material is fed in the fixing nip N, with respect to the arrow X direction), the longer heat generating element 623b in length with respect to the widthwise direction is disposed downstream of the heat generating element 823b.

On the other hand, the three heat generating elements 823c-823e provided on the back surface are the heat generating element 823d (first heat generating element), the heat generating element 823e (second heat generating element), and the heat generating element 823e (third heat generating element) in the order from the heat generating element with a longer length with respect to the widthwise direction. In this case, with respect to the rotational direction of the fixing belt 650, the longest heat generating element 823d with respect to the widthwise direction is disposed between the heat generating element 823c and the heat generating element 823e. Further, the heat generating elements 823c-823e are disposed in the order of the heat generating element 823e, the heat generating element 823d, and the heat generating element 823c from an upstream side to a downstream side with respect to the rotational direction of the fixing belt (from an upstream side to a downstream side with respect to a direction in which the recording material is fed in the fixing nip N, with respect to the arrow X direction).

Incidentally, lengths of the heat generating elements on each of the surfaces are the same with respect to the rotational direction of the fixing belt 650. In this embodiment, the lengths of all the heat generating elements 823a-823e with respect to the rotational direction of the fixing belt 650 are the same.

Further, also in the case of this embodiment, all the heat generating element 823a and 823b provided on the front surface are made longer in length with respect to the widthwise direction than the length, with respect to the widthwise direction, of the maximum size recording material capable of passing through the fixing nip N. Further, all the heat generating elements 823c-823e provided on the back surface is made shorter in length with respect to the widthwise direction than the length of the maximum size with respect to the widthwise direction. Specifically, the heat generating elements 823a and 823b which are long in the first and second are disposed on the front surface, and the heat generating elements 823d, 823c and 823e which are long in the third, fourth and fifth are disposed on the back surface.

Incidentally, it is preferable that all the heat generating elements 823a and 823b provided on the front surface are made longer in length with respect to the widthwise direction than the length of the image guarantee region with respect to the widthwise direction and the connecting portion is prevented from existing within the image guarantee region. Further, when all the heat generating elements 823c-823e provided on the back surface are smaller in length with respect to the widthwise direction than the length of the image guarantee region with respect to the widthwise direction, the length may also be made longer than the length of the maximum size recording material with respect to the widthwise direction.

As described in the third embodiment, the heating efficiency depending on the position of the heat generating element with respect to the feeding direction is (CE)>(DW)>(UP), and it is possible to obtain highest heat generating efficiency by disposing the heat generating element of which necessary input electric power is large, i.e., of which heat generating region length is long, at a position where the heating efficiency is high. In the case where the three heat generating elements different in length are provided on the same surface of the heater 800, it is possible to make the heat generating efficiency of an entirety of the heater high by disposing the heat generating elements so as to become shorter in the order of (center), (downstream), and (upstream) as shown in part (a) and (b) of FIG. 13.

Next, specific examples of the respective heat generating elements 823a-823e will be described. The five heat generating elements 823a-823e disposed on the both surfaces of the substrate 810 are different from each other in length, resistance value, and electric power in conformity with lengths of a plurality of sheets with respect to the widthwise direction. In a table 5, examples of the heat generating elements 823a-823e are shown. Incidentally, a heat generating region length in the table 5 shows a length of the heat generating element with respect to the widthwise direction, and a sheet size shows a length of the sheet with respect to the widthwise direction.

TABLE 5

| HGE*¹ | HGRL*² (mm) | CSN*³ | SS*⁴ (mm) |
|---|---|---|---|
| 823a | 318 | A4 | 297 |
| 823b | 300.4 | LTR | 279.4 |
| 823d | 278 | B4 | 257 |
| 823c | 224.2 | G_LTR_R | 203.2 |
| 823e | 203 | B5R | 182 |

*¹“HGE” is the heat generating element.
*²“HGRL” is the heat generating region length.
*³“CSN” is a corresponding sheet name.
*⁴“SS” is a sheet size.

As shown in the table 5, the lengths of the heat generating elements (heat generating region lengths) are larger than corresponding recording material sizes, respectively, and specifically, are so as to be 21 mm longer than the recording material size (sheet size).

As is apparent from the table 5, the heat generating element 623c having a heat generating region length shorter than 299 mm which is the length of the image guarantee region of the fixing device 30 in this embodiment is disposed on the back surface side where the heat generating elements 823c, 823d and 823e do not directly contact the fixing belt 650. By this, it is possible to suppress the image defect generated by the above-described partial thickness of the connecting portion of the heat generating element and the electroconductive member pattern.

### Sixth Embodiment

A sixth embodiment will be described using parts (a) and (b) of FIG. 14. In the above-described fifth embodiment, the constitution in which the two heat generating elements were provided on the front surface of the substrate and three heat generating elements were provided on the back surface of the substrate was described. On the other hand, in this embodiment, two heat generating elements are provided on the front surface of a substrate 910, and four heat generating elements are provided on the back surface of the substrate 910. Other constitutions and actions are similar to those in the above-described third to fifth embodiments, and therefore, the same constitution portions will be omitted from illustration and description or will be briefly described, and a portion different from the third to fifth embodiments will be principally described.

Part (a) of FIG. 14 shows a front surface of the substrate 910 of a heater 900 in this embodiment, and part (b) of FIG. 14 shows a back surface of the heater 900. Arrows X in the figures indicate a rotational direction of the fixing belt 650 (parts (a) and (b) of FIG. 7) in the fixing nip N, i.e., a recording material feeding direction (see FIG. 2).

The heater 900 as a heating member includes the substrate 910 and the plurality of heat generating elements 923a-923f which are provided on both surfaces of the substrate 910 and which generate heat by energization, and heats the fixing belt 650 by being contacted to the inner peripheral surface of the fixing belt 650. The substrate 910 has an insulating property and a heat-resistant property, and is formed by using a material with a further high thermo-conductive property, for example, ceramic such as alumina or aluminum nitride.

The plurality of heat generating elements 923a-923f are different from each other in length with respect to the widthwise direction crossing the rotational direction of the fixing belt 650 in other to meet recording materials of the plurality of sizes. These respective heat generating elements 923a-923f are provided substantially parallel to the widthwise direction, respectively. Further, the heat generating elements 923a-923f are disposed with intervals with each other with respect to the recording material feeding direction on the respective surfaces thereof. Further, on the front surface (first surface) of the substrate 910 which is a side where the heater 900 contacts the inner peripheral surface of the fixing belt 650, a plurality of heat generating elements are provided. In this embodiment, two heat generating elements 923a and 923b are provided on the front surface of the substrate 910. On the other hand, on the back surface (second surface) of the substrate 910 which is a side opposite from the front surface of the substrate 910, at least one heat generating element is provided. In this embodiment, four heat generating elements 923d-923f are provided on the back surface of the substrate 610. That is, in this embodiment, the number of the heat generating elements provided on the back surface is the same as the number of the heat generating elements provided on the front surface.

As shown in part (a) of FIG. 14, on the back surface of the substrate 910, the two heat generating elements 923a and 923b different from each other in length with respect to the widthwise direction are printed and baked by using silver/palladium (Ag/Pd). Further, these heat generating elements 923a and 923b are connected to two independent electrodes 922a and 922b, respectively, on one end side with respect to the widthwise direction by electroconductive member patterns 923a and 923b formed of silver (Ag) or the like, and are connected to a single common electrode 921A on the other end side by the electroconductive member patterns 923a and 923b. These heat generating elements 923a and 923b and electroconductive member patterns 924a and 924b are covered with the protective glass of, for example, 60-90 μm in thickness.

As shown in part (b) of FIG. 14, also on the back surface of the substrate 910, similarly as the front surface, the four heat generating elements 923c-923f different from each other in length with respect to the widthwise direction are printed and baked by using silver/palladium (Ag/Pd). Further, these heat generating elements 923c-923f are connected to four independent electrodes 922c and 922f, respectively, on one end side with respect to the widthwise direction by electroconductive member patterns 924c-924f formed of silver (Ag) or the like, and are connected to a single common electrode 921B on the other end side by the electroconductive member patterns 924c-924f. These heat generating elements 923c-923f and electroconductive member patterns 924c-924f on the front surface are, similarly as the front surface, as shown in part (c) of FIG. 14, covered with the protective glass of, for example, 60-90 μm in thickness.

Incidentally, in the case of this embodiment, the common electrodes 921A and 921B are formed at the substantially same position with respect to the widthwise direction on both surfaces of the substrate 910. On the other hand, the independent electrodes 922a and 922c and the independent electrodes 922c-922f are formed at different positions with respect to the widthwise direction on both surfaces of the substrate 910. However, a positional relationship between the common electrodes 921A and 921B and a positional relationship between the independent electrodes 922a and 922b and the independent electrodes 922c-922f are not limited to these.

### [Arrangement of Respective Heat Generating Elements]

Next, an arrangement of the plurality of heat generating elements 923a-923f will be described. Also, as regards the heater 900 of this embodiment, of the plurality of heat generating elements 923a-823f, the heat generating element 623b longest in length with respect to the widthwise direction is provided on the front surface of the substrate 610. Further, the two heat generating elements 923a and 923b provided on the front surface are, the heat generating element 923a (sixth heat generating element) and the heat generating element 923b (seventh heat generating element) in the order from the heat generating element with a longer length with respect to the widthwise direction. In this case, with respect to the rotational direction of the fixing belt 650 (direction in which the recording material is fed in the fixing nip N, with respect to the arrow X direction), the longer heat generating element 923a in length with respect to the widthwise direction is disposed downstream of the heat generating element 923b.

On the other hand, of the four heat generating elements 923c-923f provided on the back surface, the three heat generating elements 923c-923c are the heat generating element 923d (first heat generating element), the heat generating element 923e (second heat generating element), and the heat generating element 923c (third heat generating element) in the order from the heat generating element with a longer length with respect to the widthwise direction. In this case, with respect to the rotational direction of the fixing belt 650, the longest heat generating element 923d with respect to the widthwise direction is disposed between the heat generating element 923e and the heat generating element 923c. Incidentally, of the four heat generating elements 923c-923f provided on the back surface, the length of the heat generating element 923f with respect to the widthwise direction is shortest.

Further, as regards the heat generating elements 923c-923f, in the case where the most upstream heat generating element 923f and the most downstream heat generating element 923c with respect to the rotational direction (direction in which the recording material is fed in the fixing nip N, arrow X direction) of the fixing belt, the heat generating element 923c is longer in length with respect to the widthwise direction than the heat generating element 923f. Further, of the heat generating elements 923c-923f, longer heat generating elements 923d and 923e in length with respect to the widthwise direction are disposed between the heat generating element 923c and the heat generating element 923f which are shorter in length with respect to the widthwise direction than these (heat generating elements 923d and 923e). That is, the heat generating elements longer in length with respect to the widthwise direction of the heat generating element are disposed on a central side of the fixing nip N with respect to the arrow X direction. Further, as regards the two heat generating elements 923d and 923e, the longer heat generating element 923d in length with respect to the widthwise direction is disposed downstream of the heat generating element 923e.

Incidentally, lengths of the heat generating elements on each of the surfaces are the same with respect to the rotational direction of the fixing belt 650. In this embodiment, the lengths of all the heat generating elements 923a-923f with respect to the rotational direction of the fixing belt 650 are the same.

Further, also in the case of this embodiment, all the heat generating element 923a and 923b provided on the front surface are made longer in length with respect to the widthwise direction than the length, with respect to the widthwise direction, of the maximum size recording material capable of passing through the fixing nip N. Further, all the heat generating elements 923c-923f provided on the back surface is made shorter in length with respect to the widthwise direction than the length of the maximum size with respect to the widthwise direction. Specifically, the heat generating elements 923a and 923b which are long in the first and second are disposed on the front surface, and the heat generating elements 923d, 923e, 923c and 923f which are long in the third to sixth are disposed on the back surface.

Incidentally, it is preferable that all the heat generating elements 923a and 923b provided on the front surface are made longer in length with respect to the widthwise direction than the length of the image guarantee region with respect to the widthwise direction and the connecting portion is prevented from existing within the image guarantee region. Further, when all the heat generating elements 923c-923e provided on the back surface are smaller in length with respect to the widthwise direction than the length of the image guarantee region with respect to the widthwise direction, the length may also be made longer than the length of the maximum size recording material with respect to the widthwise direction.

As described in the fourth embodiment, the heating efficiency depending on the position of the heat generating element with respect to the feeding direction is (CE)>(DW)>(UP), and it is possible to obtain highest heat generating efficiency by disposing the heat generating element of which necessary input electric power is large, i.e., of which heat generating region length is long, at a position where the heating efficiency is high. In the case where the four heat generating elements different in length are provided on the same surface of the heater 900, it is possible to make the heat generating efficiency of an entirety of the heater high by disposing the heat generating elements so as to become shorter in the order of (center), (downstream), and (upstream) as shown in part (a) and (b) of FIG. 14.

Next, specific examples of the respective heat generating elements 923a-923f will be described. The sixth heat generating elements 923a-923f disposed on the both surfaces of the substrate 910 are different from each other in length, resistance value, and electric power in conformity with lengths of a plurality of sheets with respect to the widthwise direction. In a table 6, examples of the heat generating elements 923a-923f are shown. Incidentally, a heat generating region length in the table 6 shows a length of the heat generating element with respect to the widthwise direction, and a sheet size shows a length of the sheet with respect to the widthwise direction.

TABLE 6

| HGE*¹ | HGRL*² (mm) | CSN*³ | SS*⁴ (mm) |
|---|---|---|---|
| 923a | 318 | A4 | 297 |
| 923b | 300.4 | LTR | 279.4 |
| 923d | 278 | B4 | 257 |
| 923e | 224.2 | G_LTR_R | 203.2 |
| 923c | 203 | B5R | 182 |
| 923f | 160.7 | STMTR | 139.7 |

*¹“HGE” is the heat generating element.
*²“HGRL” is the heat generating region length.
*³“CSN” is a corresponding sheet name.
*⁴“SS” is a sheet size.

As shown in the table 6, the lengths of the heat generating elements (heat generating region lengths) are larger than corresponding recording material sizes, respectively, and specifically, are so as to be 21 mm longer than the recording material size (sheet size).

As is apparent from the table 6, the heat generating element 623c having a heat generating region length shorter than 299 mm which is the length of the image guarantee region of the fixing device 30 in this embodiment is disposed on the back surface side where the heat generating elements 923c, 923d, 923e and 923f do not directly contact the fixing belt 650. By this, it is possible to suppress the image defect generated by the above-described partial thickness of the connecting portion of the heat generating element and the electroconductive member pattern. The numbers of the heat generating elements on the front surface side and the back surface side in the present invention are not limited to those in the above-described embodiments, but a constitution in which the numbers are more than the numbers in the above-described embodiments may also be employed.

Thus, the present invention is not limited to the constitutions of the above-described embodiments, but may also be another constitution in which the effect of the present invention is obtained.

### INDUSTRIAL APPLICABILITY

According to the present invention, there is provided a belt unit and an image fixing device which are capable of enhancing a thermo-conductive property of a long heat generating element to a belt.

The present invention is not restricted to the foregoing embodiments, but can be variously changed and modified without departing from the spirit and the scope of the present invention. Accordingly, the following claims are attached hereto make public the scope of the present invention.

This application claims the Conventional Priority from Japanese Patent Applications 2019-121150 filed Jun. 28, 2019 and 2019-121154 filed Jun. 28, 2019, all disclosure of which are incorporated by reference herein.

1. A belt unit comprising:
a belt provided rotatably and for fixing a toner image on a recording material; and
a heating member for heating said belt in contact with an inner peripheral surface of said belt, said heating member including a substrate and a plurality of heat generating elements which are provided on each of a first surface on said belt side and a second surface on an opposite side from the first surface and which generate heat by energization,
wherein said plurality of heat generating elements are different from each other in length with respect to a widthwise direction crossing a rotational direction of said belt, and
wherein a length, with respect to the widthwise direction, of said heat generating element which is provided on the second surface and which is longest in length with respect to the widthwise direction is shorter than a length, with respect to the widthwise direction, of said heat generating element which is provided on the first surface and which is shortest in length with respect to the widthwise direction.

2. A belt unit according to claim 1, wherein on the first surface, three heat generating elements are provided, and
wherein in a case that said three heat generating elements provided on the first surface are a first heat generating element, a second heat generating element, and a third heat generating element in turn from a longer one in length with respect to the widthwise direction, said three heat generating elements are disposed in an order of said third heat generating element, the first heat generating element, and the second heat generating element from an upstream side toward a downstream side of a rotational direction of said fixing belt.

3. A belt unit according to claim 1, wherein on the second surface, three of said heat generating elements are provided, and
wherein in a case that said at least three of said heat generating elements provided on the second surface are a fourth heat generating element, a fifth heat generating element, and a sixth heat generating element in turn from a longer one in length with respect to the widthwise direction, said heat generating elements are disposed in an order of said sixth heat generating element, said fourth heat generating element, and said fifth heat generating element from an upstream side toward a downstream side of a rotational direction of said fixing belt.

4. A belt unit according to claim 1, wherein a number of said heat generating elements provided on the first surface is the same as a number of said heat generating elements provided on the second surface.

5. A belt unit according to claim 1, wherein a number of said heat generating elements provided on the first surface is more than a number of said heat generating elements provided on the second surface.

6. A belt unit according to claim 1, wherein one ends of respective heat generating elements provided on the first surface are electrically connected to a common electrode, and the other ends of the respective heat generating elements are electrically connected to different electrodes, respectively.

7. A belt unit according to claim 1, wherein one ends of respective heat generating elements provided on the second surface are electrically connected to a common electrode, and the other ends of the respective heat generating elements are electrically connected to different electrodes, respectively.

8. A belt unit according to claim 1, wherein a temperature detecting member for detecting a temperature of said heating member is disposed in contact with the second surface.

9. A fixing device comprising:
a belt unit claim 1; and
a pressing member contacting an outer peripheral surface of said fixing belt and for forming a nip for fixing the toner image formed on the recording material while feeding the recording material between itself and said fixing belt.

10. A fixing device according to claim 9, comprising a temperature detecting member for detecting a temperature of said fixing belt and a controller for selecting said heat generating element corresponding to a length, with respect to the widthwise direction, of the recording material fed and for controlling energization to the selected heat generating element on the basis of an output of said temperature detecting member.

11. A fixing device according to claim 9, wherein a length, with respect to the widthwise direction, of each of said plurality of heat generating elements on the first surface is larger than a length, with respect to the widthwise direction, of a maximum size recording material capable of passing through said fixing device.

12. A belt unit comprising:
a belt provided rotatably and for fixing a toner image on a recording material; and
a heating member for heating said belt in contact with an inner peripheral surface of said belt, said heating member including a substrate and a plurality of heat generating elements which are provided on a first surface on said belt side in plurality and on a second surface on an opposite side from the first surface and which generate heat by energization,
wherein said plurality of heat generating elements are different from each other in length with respect to a widthwise direction crossing a rotational direction of said belt, and
wherein a length, with respect to the widthwise direction, of said heat generating element which is provided on the second surface and which is longest in length with respect to the widthwise direction is shorter than a length, with respect to the widthwise direction, of said heat generating element which is provided on the first surface and which is shortest in length with respect to the widthwise direction.

13. A fixing device comprising:
a belt unit according to claim 12; and
a pressing member contacting an outer peripheral surface of said fixing belt and for forming a nip for fixing the toner image formed on the recording material while feeding the recording material between itself and said fixing belt.

14. A fixing device according to claim 13, wherein a length, with respect to the widthwise direction, of each of said plurality of heat generating elements on the first surface is larger than a length, with respect to the widthwise direction, of a maximum size recording material capable of passing through said fixing device.
